(19) United States
(12) Patent Application Publication
(10) Pub. No.: US 2026/0270659 A1
(43) Pub. Date: Sep. 10, 2026

(54) ROBUST BROAD-SPECTRUM DISTRIBUTED SENSING FOR SYNOPTIC SPECTRUM OCCUPANCY AND THIRD-PARTY APPLICATIONS

(71) Applicant: Xtremis, Inc., Washington, DC (US)

(72) Inventors: Gábor Hannák, Washington, DC (US); Péter Barabás, Washington, DC (US); Adam Jay Harrison, Washington, DC (US); Péter Horváth, Washington, DC (US); Miklós Maróti, Washington, DC (US); Brian Christopher Padalino, Washington, DC (US); János Sallai, Washington, DC (US); Sándor Szilvási, Washington, DC (US); Péter Völgyesi, Washington, DC (US); Shane Van Wyngaardt, Washington, DC (US)

(21) Appl. No.: 19/464,031

(22) Filed: Jan. 29, 2026

Related U.S. Application Data
(60) Provisional application No. 63/751,058, filed on Jan. 29, 2025.

(51) Int. Cl. H04W 4/38

(52) U.S. Cl. CPC H04W 4/38

(57) ABSTRACT

Disclosed is a spectrum sensing system including a data acquisition platform and spectrum occupancy application. The data acquisition platform including a plurality of radio frequency nodes distributed over a geographical area of interest, where each radio frequency node of the plurality of radio frequency nodes is operable to receive different signals in different radio frequency ranges, and determine individual occupancy indicators for each of the different radio frequency ranges by preprocessing each received different signal in the different radio frequency radio ranges. The spectrum sensing system also includes a spectrum occupancy application executed by a processor and operable to receive the determined individual occupancy indicators from each respective radio frequency node of the plurality of radio frequency nodes determined for each of the different radio frequency ranges, and generate a spectrum occupancy map of the geographical area of interest.

### CROSS-REFERENCE TO RELATED APPLICATIONS

This application claims the benefit of and priority to U.S. Provisional Patent Application No. 63/751,058 filed on Dec. 29, 2025, the entire disclosure of which is hereby incorporated by reference in its entirety for all purposes.

### BACKGROUND

Software-defined radio (SDR) is a radio communication system where components that conventionally have been implemented in analog hardware (e.g., mixers, filters, amplifiers, modulators/demodulators, detectors, and the like) are instead implemented by means of software on a computer or embedded system. While the concept of SDR is not new, the rapidly evolving capabilities of digital electronics render practical many processes which were once only theoretically possible.

A basic SDR system may consist of a computer equipped with a sound card, or other analog-to-digital converter, preceded by some form of RF front end. Significant amounts of signal processing are handed over to a general-purpose processor, rather than being done in special-purpose hardware (customized electronic circuits). Such a design produces a radio which can receive and transmit widely different radio protocols (sometimes referred to as waveforms) based solely on the software used.

Software radios have significant utility for the military and cellular telephone services, both of which must serve a wide variety of changing radio protocols in real time. In the long term, proponents expect software-defined radios to become the dominant technology in radio communications. SDRs and software defined antennas are the enablers of cognitive radio.

Spectrum occupancy monitoring (SOM) in wireless communications refers to the equipment and processes which allow the wireless spectrum manager, user, or observer to obtain sufficient information on the radio spectrum to support a decision. SOM is typically performed on a confined geographical area (e.g., a city block, a designated rural area, or a single point), on a (set of) frequency band(s) (e.g., 800 MHz-900 MHz), specific radio-frequency systems (e.g., cellular communication systems), or the like. The information obtained by SOM can refer to, e.g.: the received power in a frequency range, the ratio of time when there is signal in a frequency range and the observation time (temporal occupancy ratio), the signal-to-noise ratio (SNR) of a signal in the frequency range of that signal, the bandwidth and power of a signal, the noise floor in a frequency range. To facilitate SOM over a larger area, multiple measurement nodes with multiple RF channels/frontends can be spread over the area of interest. The data from the nodes is then collected by a central entity which further processes the gathered information. To facilitate SOM over a wide frequency range, the nodes and their frontends may be configured to measure different frequency ranges.

However, in some situations, such as battlefield conditions, the processing of the SDR provided data and the presentation of the processed data needs to be presented in an efficient and a quickly and an easily understandable manner.

### BRIEF SUMMARY

Disclosed is a spectrum sensing system that includes a data acquisition platform and a spectrum occupancy application. The data acquisition platform may include a number of radio frequency nodes distributed over a geographical area of interest. Each radio frequency node of the plurality of radio frequency nodes is operable to receive different signals in different radio frequency ranges, and determine individual occupancy indicators for each of the different radio frequency ranges by preprocessing each received different signal in the different radio frequency radio ranges. The spectrum occupancy application may be executed by a processor and operable to receive the determined individual occupancy indicators from each respective radio frequency node of the plurality of radio frequency nodes determined for each of the different radio frequency ranges, and generate a spectrum occupancy map of the geographical area of interest.

Disclosed is a spectrum occupancy monitoring system that includes a number of nodes, a central unit, and a storage device. The number of nodes may be operable to receive signals within a plurality of radio frequency bins. The central unit may be operable to communicate with each node of the plurality of nodes, and receive power spectral density vectors. The storage device may be operable to store the power spectral density vectors received from each node to the plurality of nodes. Each of the number of nodes may be operable to provide measured signal parameters, where each node of the number of nodes is operable to sample the received signals within a selected radio frequency bin of the number of radio frequency bins, generate power spectral density (PSD) data from the samples of the received signals within the selected radio frequency bin, and store the generated PSD data in a list. Each node of the number of nodes is further operable to generate PSD parameters from the stored list, and forward the PSD parameters to the central unit. The central node may be operable to provide the PSD parameters for each selected radio frequency bin of the plurality of radio frequency bins to the storage device.

### BRIEF DESCRIPTION OF THE DRAWINGS

To easily identify the discussion of any particular element or act, the most significant digit or digits in a reference number refer to the figure number in which that element is first introduced.

FIG. 1 illustrates a block diagram of an example of a spectrum occupancy monitoring system according to the disclosed subject matter.

FIG. 2 illustrates an example of a software defined radio usable in the examples of the subject matter disclosed herein.

FIG. 3 provides an example process for setting timing of hardware components of the disclosed subject matter to a standardized clock signal.

FIG. 4 illustrates an example process for accurately timestamping signals according to the disclosed subject matter.

FIG. 5 illustrates an example process for distributing commands to system nodes for coordinating actions according to the disclosed subject matter.

FIG. 6 illustrates an example system block diagram of a SOM system with processing steps according to the disclosed subject matter.

FIG. 7 illustrates another example process for generating and outputting a list of PSD parameter vectors according to the disclosed subject matter.

FIG. 8 illustrates a further example process for generating and outputting a list of PSD parameter vectors according to the disclosed subject matter.

FIG. 9 illustrates yet another example process for generating and outputting a list of PSD parameter vectors according to the disclosed subject matter.

FIG. 10 illustrates yet a further example process for generating and outputting a list of PSD parameter vectors according to the disclosed subject matter.

FIG. 11 illustrates an example process for merging spectrum occupancy results into a global spectrum occupancy view according to the disclosed subject matter.

FIG. 12 illustrates an example of a process for performing baseline spectrum occupancy subtraction according to the disclosed subject matter.

FIG. 13 illustrates an example process for observing spectrum occupancy of a monitored spectrum according to the disclosed subject matter.

FIG. 14A illustrates an example process for generating an alarm based on a latest SO vector with respect to a lookback period according to the disclosed subject matter.

FIG. 14B illustrates another example process for generating an alarm based on a latest SO vector with respect to a lookback period according to the disclosed subject matter.

FIG. 15 illustrates an example of partitioning a bandwidth for monitoring according to the disclosed subject matter.

FIG. 16 illustrates another example of partitioning a bandwidth for monitoring according to the disclosed subject matter.

FIG. 17 illustrates an example of a user interface presentation of the output of the spectrum occupancy monitoring system examples disclosed herein.

FIG. 18 illustrates another example of a user interface presentation of the output of the spectrum occupancy monitoring system examples disclosed herein.

FIG. 19 illustrates an example of a power spectral density vectors and an output of the respective nodes according to the disclosed subject matter.

FIG. 20 illustrates an example of a user interface for presenting spectrum occupancy monitoring results according to the disclosed subject matter.

FIG. 21 illustrates another feature of the exemplary first area of the user interface example of FIG. 20.

FIG. 22 illustrates an exemplary second area of the user interface example of FIG. 20.

FIG. 23 illustrates a block diagram of an exemplary output device for presenting the exemplary SOM output according to the disclosed subject matter.

### DETAILED DESCRIPTION

In case of multiple nodes performing spectrum occupancy monitoring (SOM) over a large area, the nodes will be disconnected. This comes with a set of problems, such as a lack of precise time synchronization for controlling/configuring the measurements by the respective nodes.

For example, the identification of single transmissions creates problems. The issue of two nodes identifying a single transmitted signal as two separate transmissions stems from discrepancies in the respective nodes' time references. If the respective nodes are not precisely synchronized, they might record the same transmission at slightly different times, interpreting them as distinct events. This misinterpretation can lead to overestimation of spectrum usage, inefficient allocation of resources, and potentially, increased interference if the system incorrectly assumes more spectrum availability than there actually is. Additionally, imprecise time synchronization may lead to misaligned frequency hopping schedules. For example, in a system where multiple sensors coordinate to cover different parts of the spectrum, precise synchronization ensures that all nodes hop frequencies in unison, thereby maximizing the coverage and efficiency of spectrum monitoring. Lack of synchronization between the respective nodes can lead to scenarios where sensors at the respective nodes inadvertently hop to the same frequency band or miss critical frequency bands altogether. This misalignment not only reduces the SOM system's overall sensing efficiency but can also create blind spots in the monitored spectrum. Yet another issue created by imprecise time synchronization may degrade joint perception and decision making by the SOM system. For example, in a distributed monitoring system, nodes often need to aggregate their observations to derive complete information about the spectrum usage. In an example, detecting a signal's direction, strength, or even identifying unauthorized usage may, in some instances, require aggregating data from multiple nodes. Precise time synchronization ensures that the data from different nodes can be accurately combined to form a coherent picture of the spectrum environment. Misaligned data can lead to incorrect conclusions, impacting the system's ability to manage and protect the spectrum effectively.

The challenges include high precision timestamping that can be difficult to obtain. For example, at a 100 MHz sampling frequency, each sample represents a 10-nanosecond slice of time. To achieve 10-nanosecond timestamp accuracy for each sample means that the timestamping mechanism must be able to resolve the time of arrival or sampling to within the duration of a single sample cycle. This level of precision is challenging due to several factors, such as clock stability and accuracy, jitter and latency in digital systems, and real-time system constraints. The 100 MHz sampling frequency and 10-nanosecond time slices are typical for commercial off the shelf devices, but other sampling frequencies and time slices may be used depending upon the capabilities of equipment being used. Of course, other sampling frequencies and time slices may be used, such as 25 MHz and 40 nanoseconds, 50 MHz and 20 nanoseconds, or the like.

With regard to clock stability and accuracy, most commercial off-the-shelf (COTS) microcontrollers and processors, for example, do not have internal clocks with the necessary stability or accuracy. High-precision applications typically require external time sources like global positioning system (GPS) signals or atomic clocks, which can provide the needed accuracy but are challenging to integrate directly for real-time sample timestamping.

As for jitter and latency in digital systems, electronic systems introduce various delays and jitter (timing variability) as signals propagate through circuits, are processed by digital logic, or are handled by software. Achieving consistent 10-nanosecond accuracy in such an environment is challenging, as even minor variations can lead to significant errors relative to the required precision level.

Most COTS microcontrollers and microprocessors when applied in the type of SOM envisioned herein suffer from real-time system constraints because they are not designed for hard real-time operations where actions must occur precisely at predetermined times as a result, custom microcontrollers are more applicable and COTS microcontrollers are avoided. Achieving the timing precision described herein is provided by specialized hardware and software designs that can preemptively manage and execute tasks with minimal delay and jitter.

An additional aspect of the described subject matter is the high precision coordination of the different actions to be taken. For example, actions are coordinated with high precision by directing the entire network's radio frontends to hop to another channel in unison with, for example, 10-nanosecond precision involves additional complexities. Commands sent from a central controller to the nodes must be received and executed simultaneously. Given the variability in communication delays and the execution time within each node, the control is configured to ensure that all nodes switch frequencies at exactly the same moment is highly challenging.

Aggregation and transmission of the recorded spectrum data to the central node for processing and viewing. Typically, the amount of recorded data is orders of magnitude larger than what the network link between each node and the central unit allows for an RF channel/frontend could generate, depending on the configuration, one or more 2048 long float32/float64 arrays every millisecond or even faster. With 2-8 frontends per node, this amounts to a transmission payload of tens-hundreds of MB per second, which is prohibitive, especially in outdoor, ad-hoc deployments in unknown environments. For IQ sample recordings, the data orders of magnitude more.

SOM system results coming from a wide frequency range, from a large geographic area, over a long time window are practically impossible for the human operator to ingest and interpret. There is a need for meaningful and informative representation of the information so Examples of intelligence use cases include: a. comparing two time ranges in terms of spectrum usage (e.g., “overnight background” vs “daylight” radio environment/spectrum occupancy (SO)); and b. informing the user about unusual radio activity (e.g., occupancy in a band where previously there was no occupancy).

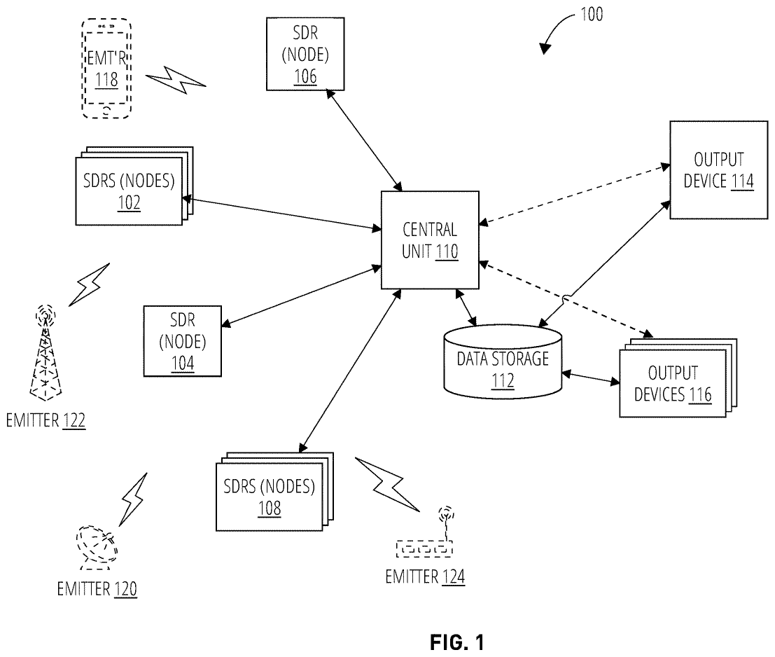

FIG. 1 illustrates an example of a spectrum occupancy monitoring system according to the disclosed subject matter.

The spectrum occupancy monitoring system 100 may be implemented as a data acquisition platform including a plurality of radio frequency nodes distributed over a geographical area of interest. For example, the spectrum occupancy monitoring system 100 may include a number of software defined radios 102, 104, and 106 (also referred interchangeably herein as “nodes”), a central unit 110, a data storage 112, an output devices 114 and 116.

The spectrum occupancy monitoring system 100 is operable to monitor signals output by a number of emitters 118, 120, 122, and 124. The number of emitters 118, 120, 122, and 124 may be operable to transmit signals in the range of 0-18 GHz.

The software defined radios 102, 104, 106 and 108 are custom software defined radios (SDRs) that are respective nodes within the spectrum occupancy monitoring system 100. The custom features, both structural and functional, of the SDRs 102, 104, 106 and 108 are described in more detail with reference to the other examples. The software defined radios 102 and 108 represent a number of SDRs that are configured to receive signals from emitters, such as 118-124, and provide data regarding the 0-18 GHz signals generated by the emitters 118-124 to the central unit 110.

The central unit 110 may also be an SDR configured in a manner like the SDRs 102, 104, 106, and 108. As described with reference to later examples, the respective SDRs 102, 104, 106, and 108 may include processors and circuitry (e.g., hardware, software, radio frequency receivers and transmitters, and the like) operable to send signal data (e.g., processed signal data, raw signal data, or a combination of both) to the central unit 110. The central unit 110 may be operable to store the received signal data in the data storage 112. Additionally, the central unit 110 may be operable to perform the functions described herein with reference to the later examples.

The data storage 112 may be a memory device or a server that is accessible by the output devices 114 and 116. The output device 114 may be a console or computer at a location remote from the central unit 110. Similarly, the output devices 116 may be computers or consoles that are remote from the central unit 110, may be co-located with the central unit 110, or both. The output devices 114 and 116 may be configured with a spectrum occupancy application executed by a processor.

The output devices 114 and 116 are operable to access signal data processed according to the later described examples. In an example, the output devices 114 and 116 may be electronic devices, such as workstations or the like, portable devices, such as tablets, laptops, digital assistants, or the like, which may be communicatively coupled either via wired or wireless connections to the central unit 110 and/or the data storage 112. The output devices 114 or 116 may be operable to execute a computer application that configures the respective output device to present the processed signal data in an easily-understood format, as described with respect to later examples.

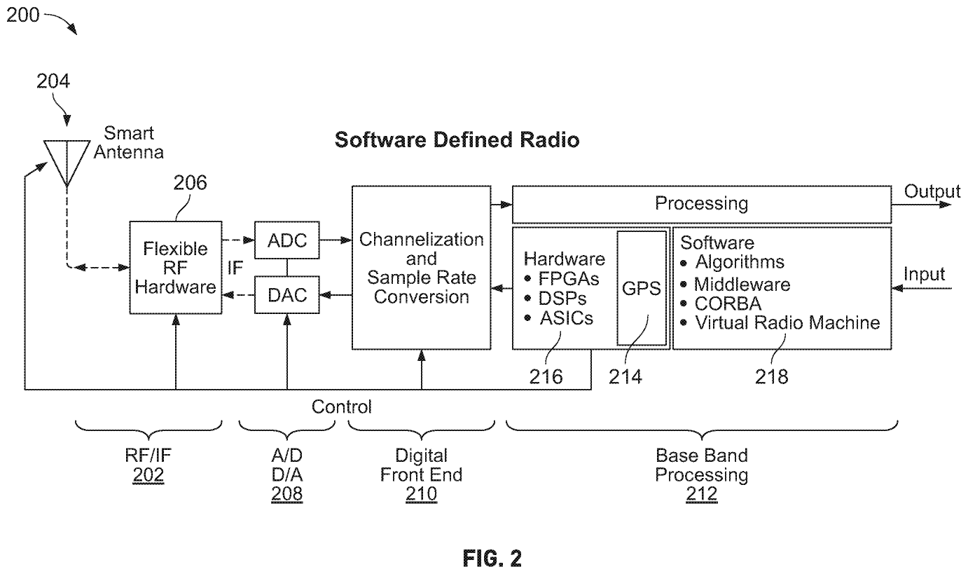

FIG. 2 illustrates an example of a software defined radio usable in the examples of the subject matter disclosed herein.

In an example, the time enhanced SDR 200 may be usable in the spectrum occupancy monitoring (SOM) system 100 as described in FIG. 1. The time enhanced SDR 200 may include a radio frequency-intermediate frequency (RF/IF) analog front end 102, a smart antenna 204, flexible RF hardware 206, an AD/DA converter 208, a digital front end 210, and a base band processing 212 component. The base band processing 212 component may include GPS circuitry 214, other hardware 216, and software 218.

In the example, the smart antenna 204 of the time enhanced SDR 200 used in the SOM system described herein is an omnidirectional antenna for RF signal acquisition tuned to receive signals in the frequencies between approximately 0-18 GHz. Frequencies above 18 GHz (k-band and above) are mostly used for directional communications, and the smart antenna 204 is not configured for directional communications as such the sensing of the frequencies for directional communications is not addressed herein.

The flexible RF hardware 206 is operable to allow different frequencies within the 0-18 GHz spectrum of interest that is being monitored by the SOM system 100 (shown in FIG. 1).

The digital front end 210 may configured to be 2-8 frontends per time enhanced SDR 200 (i.e., node), this amounts to a transmission payload of tens-hundreds of MB per second, which is prohibitive, especially in outdoor, ad-hoc deployments in unknown environments. For IQ sample recordings, the data orders of magnitude more.

In an example, the GPS-based synchronization leverages atomic clock-driven signals from satellites to achieve cross-network timing accuracy within 10 nanoseconds, enabling precise sample timestamping and coordinated actions across distributed nodes. Using, for example, in the base band processing 212 circuitry of the time enhanced SDR 200, a COTS GPS circuitry 214 in conjunction with a programmable hardware (FPGA) in the hardware 216 ensures high precision in operations and radio frequency (RF) performance, for example, by aligning clock periods to avoid frequency beating and interference. A beat frequency is when two signals close in frequency combine to produce a new signal at the difference of the two signals frequencies. This new combined signal, known as the beat frequency, contains information about both original signals, which is not ideal for spectrum occupancy monitoring.

The configuration of the time enhanced SDR 200 offers time synchronization across the distributed network of spectrum sensing devices (e.g., SDRs 102, 104, 106 and 108). The time synchronization is crucial for tasks requiring stringent time coordination, such as sample timestamping at a 100 MHz frequency (which translates to an approximately 10-nanosecond accuracy) and synchronized actions across multiple nodes (i.e., SDRs).

In the disclosed approach, the GPS circuitry 214 leverages the GPS Technology that is widely used for precise timekeeping due to its ability to provide accurate global time standards. As is known, each GPS satellite carries atomic clocks and broadcasts time signals with remarkably high accuracy. The GPS circuitry 214 of each time enhanced SDR 200 may use the GPS signals to synchronize their clocks with one another to within a few nanoseconds of Coordinated Universal Time (UTC).

Additionally, the GPS circuitry 214 is equipped with pulse-per second (PPS) general purpose input/output (GPIO) outputs. These PPS signals provide a highly accurate timing signal, marking the start of each second with a precise pulse. By integrating these signals into a timing subsystem, each node (e.g., software defined radios 102-108) can achieve synchronization with the global GPS time standard to a remarkably high degree of accuracy.

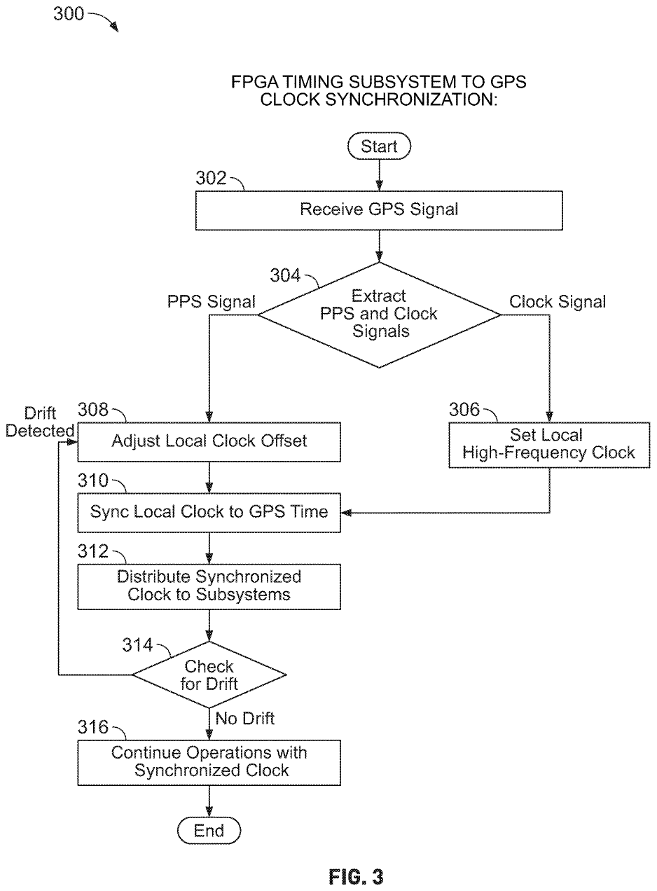

In addition, the high-frequency clock outputs of GPS chips, characterized, for example, by their voltage-compensated and temperature-compensated stable oscillators, provide an ideal basis for generating the system's clock and RF Phase-Locked Loop (PLL). This inherent stability ensures minimal drift and high accuracy, making it highly suitable for precision tasks in our system that demand consistent and reliable timing. A GPS-synchronized local clock in the programmable logic (FPGA) of hardware 216 may is implemented as shown with reference to the example of FIG. 3.

A benefit of the FPGA-Based Programmable Hardware Integration in the hardware 216 is the timing subsystem connection and the high-frequency clock output utilization.

The pulse-per-second (PPS) output from the GPS circuitry 214 may be connected, for example, to the timing subsystem of FPGA-based programmable hardware 216. As is known, field-programmable gate arrays (FPGAs) are highly versatile and can be programmed to perform a wide range of tasks with precise timing control. In addition, FPGAs avoid the jitter and latency of software based systems. By leveraging the FPGA's capability to process nanosecond accurate PPS signals, the FPGA based timing subsystem can maintain a precise local clock for timekeeping purposes. Because GPS timing is used for synchronization, the local clocks of the FPGA are precisely synchronized across the entire network.

Additionally, GPS circuitry 214 may provide a high-frequency clock output, which is used as an input to the clock distribution network within the custom hardware 216. For example, this clock serves as the primary time base for generating higher-frequency clocks necessary for local operations, including local clocking and RF mixing. Using the GPS circuitry 214 as a clock source significantly reduces the overall hardware costs of the spectrum occupancy monitoring system 100 of FIG. 1.

The software 218, when executed by a processor, may be operable to enable the processor to process the received data and provide it to the central node, such as central unit 110 of FIG. 1.

FIG. 3 provides an example process for setting timing of hardware components to a standardized clock signal:

The system comprises a process 300 that enables FPGA timing subsystem to GPS clock synchronization. The process 300 may have multiple steps including steps to receive global positioning system signal 302, extract pulse per second and clock signals 304, set local high frequency clock 306, adjust local clock offset 308, synchronize local clock to GPS time 310, distribute synchronized clock to subsystems 312, check for drift 314, and continue operations with synchronized clock 316.

In the process 300, the respective nodes including the central node may receive a GPS signal at 302. At 304, a processor of the base band processing 212 of FIG. 2 is operable to extract from the spectrum being monitored the PPS and the check signals, which are used to set the PPS and the clock.

At 306, the processor is operable to set the local high frequency clock using the check signal. Additionally, the PPS signal is used at 308 to adjust the local clock offset.

More specifically, the FPGA subsystem within hardware 216 of base band processing 212 shown in FIG. 2 may receive two signals from the GPS hardware: a pulse-per-second signal (a short pulse at the start of every second, synchronized to the global GPS clocks) and a high-frequency oscillator output. For example, the FPGA may use the high-frequency oscillator as an input to implement a free-running counter. Because it is free-running, the counter may have an offset from global GPS time and may also have a drift (e.g., its frequency slightly differs from the nominal frequency due to temperature and voltage fluctuations, and hardware manufacturing differences). In an example, free-running counter may be turned into a synchronized clock source by aligning its phase and frequency to GPS time using the PPS signal. In an example, phase alignment may be performed by using the PPS signal to calibrate and adjust a local free-running oscillator periodically, turning it into a synchronized clock by aligning its ticks with the precise one-second intervals marked by the GPS signal. Similarly, frequency alignment may be performed by near continuous monitoring by the system for any drift in the local clock against the GPS time. For example, clock drift of the local FPGA clock with a nominal frequency may be detected by comparing the elapsed time between two consecutive PPS signals against the expected interval, revealing any deviation from the nominal frequency. Based on the results of the spectrum occupancy monitoring, clock drift compensation may be applied to the local clock by adjusting its frequency or phase to align with subsequent PPS signals, ensuring monotonicity to prevent any backward time adjustments that could disrupt chronological data integrity and system synchronization.

Using the local clock offset and the set local high frequency clock, the local time is synchronized to the GPS time at 310. Upon synchronizing the local time, the processor is operable to distribute the synchronized clock to other subsystems at 312. At 314, the processor may be operable to monitor the clock for drift. If drift is detected at 314, then the process 300 returns to 308 for adjustment using the local clock offset. And steps 308-314 are repeated. If no drift is detected at 314, the processor continues operations with the synchronized clock (316). An acceptable amount of drift may be, for example, +/−0.5 times the sample time over 1 second, where sampling times may be 10 nanoseconds, 20 nanoseconds, 40 nanoseconds, or the like as discussed above.

The precise time synchronization for controlling/configuring the measurements addresses a number of potential issues. For example, a lack of precise time synchronization can lead to decreased performance:
1. Identification of Single Transmissions: The issue of two nodes identifying a single transmitted signal as two separate transmissions stems from discrepancies in the nodes' time references. If the nodes are not precisely synchronized, they might record the same transmission at slightly different times, interpreting them as distinct events. This misinterpretation can lead to overestimation of spectrum usage, inefficient allocation of resources, and potentially, increased interference if the system incorrectly assumes more spectrum availability than there actually is.
2. Misaligned Frequency Hopping Schedules: In the examples of the disclosed system where, multiple sensors coordinate to cover different parts of the spectrum, precise synchronization ensures that all nodes hop frequencies in unison, thereby maximizing the coverage and efficiency of spectrum monitoring. Lack of synchronization can lead to scenarios where sensors inadvertently hop to the same frequency band or miss critical frequency bands altogether. This misalignment not only reduces the system's overall sensing efficiency but can also create blind spots in the monitored spectrum.
3. Joint Perception and Decision Making: In a distributed monitoring system, nodes often need to aggregate their observations to derive complete information about the spectrum usage. For example, detecting a signal's direction, strength, or even identifying unauthorized usage requires aggregating data from multiple nodes. Precise synchronization ensures that the data from different nodes can be accurately combined to form a coherent picture of the spectrum environment. Misaligned data can lead to incorrect conclusions, impacting the system's ability to manage and protect the spectrum effectively.

By maintaining the clock synchronization as described in the example of FIG. 3, the above performance degradations, such as a, b, and c, may be minimized. Of course, other system performance degradations may also be minimized or prevented.

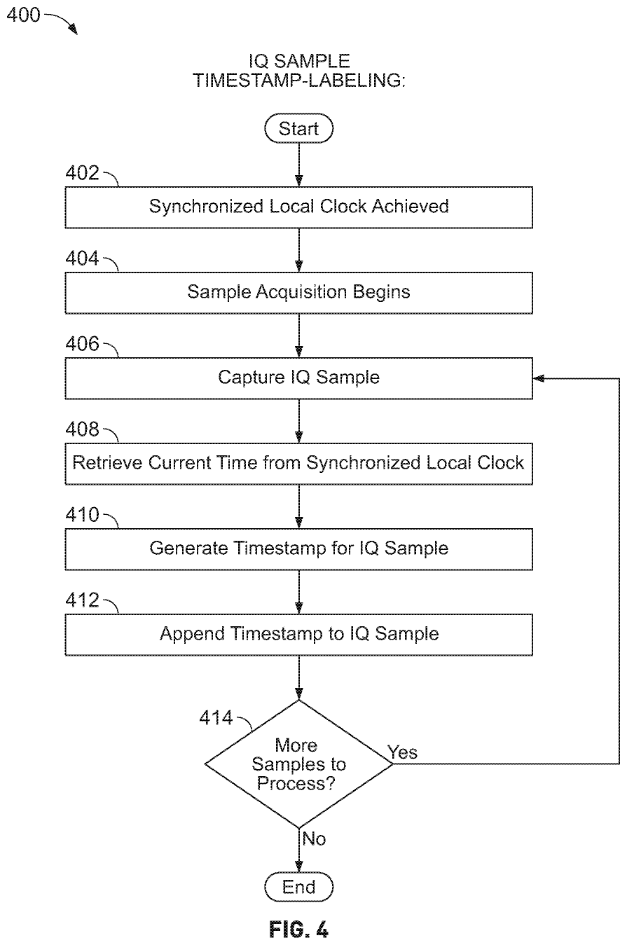

FIG. 4 illustrates an example process for accurately timestamping signals according to the disclosed subject matter.

An FPGA-based subsystem as provided in each node, such as time enhanced SDR 200, plays a pivotal role in the network's operation by a) appending precise timestamps, derived from global GPS time, to each recorded sample, ensuring data accuracy and integrity, and b) executing coordinated actions such as frequency hopping, as directed by commands from a central controller which include the exact GPS time when these actions should occur, thus maintaining synchronization across the distributed network. This dual functionality leverages the precision and programmability of FPGAs, enabling both real-time data annotation and synchronized network-wide operations based on a unified time standard.

To enable effective management and protection of the spectrum by the SOM system, each respective node is configured to time label their recorded data. SDRs typically operate with a sampling frequency of at least 80-100 MHz, as this range is essential for effectively demodulating common waveforms that exhibit bandwidths around 40-50 MHz. This requirement aligns with the Nyquist theorem, ensuring that the sampling frequency is at least twice the highest frequency present in the signal to accurately capture and reconstruct the waveform without aliasing. Accurately timestamping RF samples at a 100 MHz sampling frequency with 10-nanosecond accuracy and carrying out coordinated actions across a spatially distributed network with similar precision presents a series of technical challenges. These challenges stem from the high demands on timing precision, the need for synchronization across distributed nodes, and the limitations of current hardware.

Maintaining nanosecond accuracy via an FPGA-based timing subsystem, such as hardware 216 which is coupled to base band processing 212 of time enhanced SDR 200) involves a multi-faceted approach to achieve a sample-accurate timestamping and synchronization of frequency hopping schedules in a distributed network of time enhanced SDRs, such as 200 of FIG. 2.

As mentioned above, the FPGA-based timing subsystem distributes the GPS-synchronized clock to all nodes in the spectrum occupancy monitoring system. This ensures that every part of the spectrum occupancy monitoring system operates on the same time base thereby enabling accurate timestamping.

The spectrum occupancy monitoring system such as 100 of FIG. 1, via one or more of nodes 102-108 may be operable to implement an in-phase and quadrature sample timestamping process, such as process 400. The process 400 may include as an initial step, an FPGA may send signals to other nodes that achieves a synchronized local clock at 402. Upon achieving the synchronized local clock, the At 404, the respective nodes of the spectrum occupancy monitoring system begin acquiring samples of respective portions of the spectrum being monitored. Each node captures an IQ sample (406) and retrieves a current time from a synchronized clock 408.

At 410, for each sample acquired, the FPGA appends a timestamp derived from the GPS-synchronized clock to the IQ sample. Given the nanosecond accuracy of the local clocks, this process allows for precise alignment of samples across the network, facilitating accurate analysis and reconstruction of the signal environment across spatially distributed nodes. At 412, the FPGA appends a time stamp to the IQ sample. If there are more samples as determined at 414, the process 400 returns to step 406.

In addition to the advantages discussed with reference to FIGS. 2-4, FPGAs excel in handling tasks with minimal latency and jitter due to their parallel processing capabilities and direct control over hardware resources. By at least the FPGA logic of FIG. 4, the spectrum occupancy monitoring system minimizes the delay between the actual sampling moment and the timestamping process, further enhancing accuracy. The exemplary timestamping process 400 may be integrated directly into the FPGA's data path, allowing for real-time appending of timestamps as samples are captured. This approach is beneficial because it leverages the FPGA's capability of precise timing control, ensuring that each sample is immediately and accurately timestamped upon acquisition, without introducing delays or variability.

Examples of the benefits obtained by the disclosed examples include Synchronization of Frequency Hopping Schedules Coordinated Control Signals and Programmable Logic Advantage.

In an example of the Synchronization of Frequency Hopping Schedules Coordinated Control Signals, the FPGA-based RF frontend controller subsystem uses the GPS-synchronized clocks to generate control signals for frequency hopping, ensuring that all nodes in the network switch frequencies simultaneously. This coordination is critical for maintaining the integrity of the collected data and avoiding gaps or overlaps in frequency coverage.

In an example, of the Programmable Logic Advantage, the FPGAs can be programmed to implement precise timing sequences and control logic for frequency hopping actions. This programmability allows the system to adapt to various frequency hopping patterns and schedules, all while maintaining tight synchronization across the network.

More specifically, at step 410, the time labeling of the data recorded by each respective node may be performed at a sampling frequency of 80-100 MHz. For example, SDRs typically operate with a sampling frequency of at least 80-100 MHz, as this range is essential for effectively demodulating common waveforms that exhibit bandwidths around 40-50 MHz. This requirement aligns with the Nyquist theorem, ensuring that the sampling frequency is at least twice the highest frequency present in the signal to accurately capture and reconstruct the waveform without aliasing. Accurately timestamping RF samples at a 100 MHz sampling frequency with 10-nanosecond accuracy and carrying out coordinated actions across a spatially distributed network with similar precision presents a series of technical challenges. These challenges stem from the high demands on timing precision, the need for synchronization across distributed nodes, and the limitations of current hardware. In more detail, the disclosed examples provide:
4. High Precision Timestamping. At a 100 MHz sampling frequency, each sample represents a 10-nanosecond slice of time. To achieve 10-nanosecond timestamp accuracy for each sample means that the timestamping mechanism must be able to resolve the time of arrival or sampling to within the duration of a single sample cycle. This level of precision is challenging due to several factors:
   Clock Stability and Accuracy: Most commercial off-the-shelf (COTS) microcontrollers and processors do not have internal clocks with the necessary stability or accuracy. High-precision applications typically require external time sources like GPS or atomic clocks, which can provide the needed accuracy but are challenging to integrate directly for real-time sample timestamping.
   Jitter and Latency in Digital Systems: Electronic systems introduce various delays and jitter (timing variability) as signals propagate through circuits, are processed by digital logic, or are handled by software. Achieving consistent 10-nanosecond accuracy in such an environment is challenging, as even minor variations can lead to significant errors relative to the required precision level.

With an accurate timestamp, the spectrum occupancy monitoring system 100 may be operable to coordinate actions of the sensor nodes (e.g., 102-108 of FIG. 1).

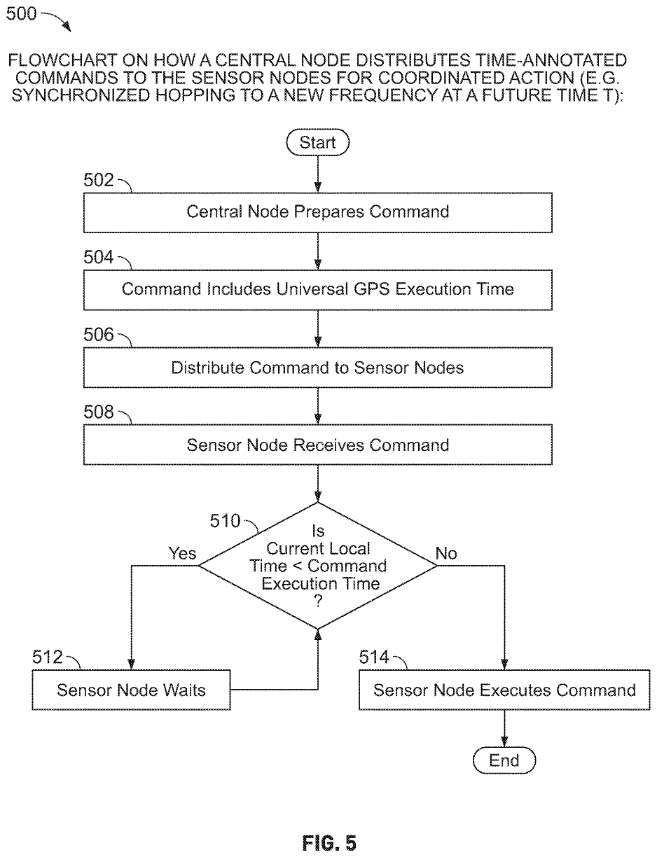

FIG. 5 illustrates an example process of coordinating action of sensor nodes according to the disclosed subject matter. The process 500 is an example of how a central node, such as central unit 110 of FIG. 1, may distribute time-annotated commands to the sensor nodes for coordinated action (e.g., synchronized hopping to a new frequency at a future time t).

The system configuration described with respect to FIGS. 1 and 2, enables coordinated actions with high precision. For example, directing the entire network's radio frontends to hop to another channel in unison with 10 nanosecond precision involves additional complexities, such as a) command propagation and execution time and b) real-time system constraints. As shown in process 500, the commands sent from a central controller to the nodes must be received and executed simultaneously. Given the variability in communication delays and the execution time within each node, ensuring that all nodes switch frequencies at exactly the same moment is highly challenging. Since, most COTS microcontrollers and microprocessors are not designed for hard real-time operations where actions must occur precisely at predetermined times (therefore COTS microcontrollers should be avoided). Achieving such timing precision often requires specialized hardware and software designs that can preemptively manage and execute tasks with minimal delay and jitter as described herein. The system comprises a process 500 that has multiple steps including steps for a processor of the central node that prepares command 502. The command generated by the processor includes universal GPS execution time (504). The central node processor of the central unit 110 is operable to distribute commands to sensor nodes 506, a sensor node receives command 508, determine if current local time is less than command execution time 510, a sensor node waits until command execution time 512, and a sensor node executes command 514.

A more detailed operational example may be beneficial. In the operational example, the process of implementing coordinated action is described with reference to FIG. 4. An example execution flow is described below:

At 502, when the synchronized local clock has been achieved, the central unit prepares a command specifying: “Tune to center frequency of 2.4 GHz and collect 1 second worth of PSD data starting at exactly 12:34 μm.”

At 504, this command includes a precise execution timestamp (which is sufficiently “far” enough in the future, allowing enough time for message propagation to take place), leveraging the globally GPS synchronized clocks of all nodes to ensure nanosecond accuracy.

At 506, the central unit may use, for example, IP multicast (or IP broadcast if all nodes need to be addressed) to send the command to a predefined group address that all targeted nodes are listening to.

At 508, nodes receive the multicast (or broadcast) message and parse the command details, including the exact future time for action.

At 510, each sensor node schedules the task locally, using their GPS synchronized local clock to wait until the specified start time. Each node confirms that the current local time is the command execution time at 510. If the current local time is not equal to the command execution time, the node waits at 512. If the current local time is equal to the command execution time, the node begins executing the command (514). For example, in step 514, at exactly 12:34 μm, as synchronized across all nodes, each sensor tunes to the 2.4 GHz frequency. Each node collects PSD data for exactly one second, as commanded.

This coordinated action ensures that all nodes execute the task simultaneously, maintaining system integrity, and data coherence.

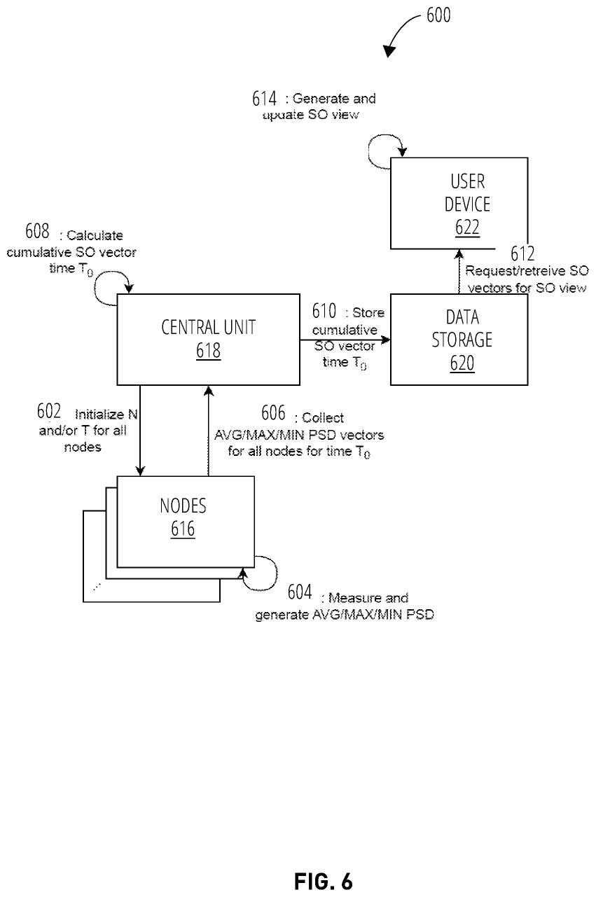

FIG. 6 illustrates an example system block diagram of a SOM system with processing steps according to the disclosed subject matter. Once the local clock synchronization is achieved, the process 600 may commence. The SOM system may include a number of nodes 616 that are communicatively coupled to a central unit 618. Each node of the nodes 616 and central unit 618 may be an SDR, such as time enhanced SDR 200 of FIG. 2. The central unit 618 may be configured substantially in the same manner as each of node of nodes 616. In some examples, each node of the nodes 616 are operable to communicate with one another and are configurable to operate in an IP broadcast, an IP multicast, a point-to-point communication environment, or combination thereof. As such, any of node of nodes 616 may also be configured to function as a central unit 618, thereby enabling redundancy in the case of failure or outage at one of the respective nodes 616. Note that the data storage 620 may be an integral part of the central unit 618, separate from the central unit 620, or a combination of being partially integral with and separate from the central unit 618. In this example, the data storage 620 is shown as separate entity so step 610 may be illustrated and explained.

When monitoring frequencies within the radio frequency spectrum being monitored, each node of the nodes 616 is operable to measure or generate received power per frequency bin or power spectral density (PSD) measurements based on RF signals received in the respective frequency bin. A frequency bin may be a portion of the monitored spectrum being monitored by the respective node. In some examples, the frequency bin may be automatically selected based on a list of frequency bins or may be selected in response to a user input device. The measured or generated received power per frequency bin or PSD may be measured or generated by the respective nodes on a millisecond (ms) basis or even faster, per frontend (e.g., digital front end 210), for the configured bandwidth of the respective frontend (hence, the need for 2-8 digital front ends). Both the measured or generated received power per frequency bin or PSD is referred to herein as “PSD,” and the expressions may be used interchangeably.

The central unit 618 may also be coupled to data storage 620, which is operable to store the data generated by part or all of nodes 616. Additionally, the data storage 620 may be operable to store data and signals generated by the central unit 618. A user device 622 may be a computing device having a user interface (UI) that presents the SO data in an understandable format.

The process 600 illustrates a general process that may be modified depending upon the granularity of the data desired, the operating environment (e.g., an amount of interference, quality of the communication links of the nodes 616, the central unit 618, and the user devices 622), other conditions, and the like.

In the process 600, the central unit 618, after a synchronized local clock is achieved, the central unit 618 may begin the process by initializing the monitoring period threshold of the respective nodes at 602. For example, the monitoring period threshold may include one or more monitoring parameters, such as a number of samples N that the node may collect, a time period T over which samples are collected, or a combination of both. The central unit 618 is operable to initialize monitoring period threshold for all nodes 602. In response, the nodes 616 measure and generate parameter power spectral density (PSD) vectors 604. The parameter PSD vectors may include an average PSD of the PSD measurements, a maximum PSD of the PSD measurements, a minimum PSD of the PSD measurements, or the like.

At the end of the monitoring period threshold, each node of the nodes 616 sends its respective parameter PSD vectors to the central unit 618 to collect parameter PSD vectors for all nodes 606. From the collected parameter PSD vectors for all nodes 616, the central unit 618 may be operable to determine a cumulative SO vector at 608. Upon determining the cumulative SO vector, the central unit 618 may be operable to store cumulative SO vector 610 in data storage 620. The data storage 620 may be like the data storage 112 of FIG. 1. A user device 622 may be coupled to the data storage 620 and be operable to request or retrieve the stored cumulative SO vector and thereby obtain SO vectors for viewing 612. The user device 622 may include a processor operable to execute a spectrum occupancy application. The spectrum occupancy application may be operable to receive the determined individual occupancy indicators from each respective radio frequency node of the plurality of radio frequency nodes. The individual occupancy indicators are determined for each of the different radio frequency ranges (i.e., frequency bins) and are used to generate a spectrum occupancy map of a geographical area of interest. Based on the presented SO vectors, an application executing on the 622 may be operable to generate and/or update the SO view 614.

Using FIG. 6 as a reference, an operational example is provided. An exemplary spectrum occupancy monitoring system in the operational example may include a number of nodes, a central unit, and a storage device. As discussed above, the number of nodes may be operable to receive signals within a plurality of radio frequency bins. The central unit may be operable to communicate with each node of the plurality of nodes, and receive power spectral density vectors. The power spectral density vectors may be used to generate individual occupancy indicators for each of the different radio frequency ranges (i.e., frequency bins) by preprocessing each received different signal in the different radio frequency radio ranges. For example, the determined individual occupancy indicators include power spectral density measurements for each radio frequency of the different radio frequency ranges within the geographical area of interest. The storage device may be operable to store the power spectral density vectors received from each node to the plurality of nodes. Additionally, each of the number of nodes may be operable to provide measured signal parameters, where each node of the number of nodes is operable to sample the received signals within a selected radio frequency bin of the number of radio frequency bins, generate power spectral density (PSD) data from the samples of the received signals within the selected radio frequency bin, and store the generated PSD data in a list. Each node of the number of nodes is further operable to generate PSD parameters from the stored list, and forward the PSD parameters to the central unit. The central node may be operable to provide the PSD parameters for each selected radio frequency bin of the plurality of radio frequency bins to the storage device. The following examples provide additional features and/or functions to examples described with reference to FIG. 6.

In some embodiments, the spectrum occupancy application may apply differential weighting to individual occupancy indicators based on various quality factors. For example, weighting factors may be assigned based on signal strength, node reliability, confidence values, or spatial proximity of the respective radio frequency nodes to a point of interest within the geographical area. Higher quality indicators may receive greater weight in the combination process, while lower quality indicators may be assigned reduced weights.

In a particular implementation, weights may be assigned based on signal-to-noise ratio (SNR) measurements from each node. For instance, individual occupancy indicators from nodes reporting SNR values above a threshold (e.g., SNR>20 dB) may be assigned weights in the range of 0.7 to 1.0, indicating high confidence. Indicators from nodes with moderate SNR values (e.g., 10 dB<SNR≤20 dB) may receive weights between 0.4 and 0.7. Indicators from nodes with lower SNR values (e.g., SNR≤10 dB) may be assigned weights of 0.1 to 0.4, reflecting reduced reliability.

The weighted combination of individual occupancy indicators may be calculated according to the formula:

$$Combined\_Occupancy = \sum ( {w}_{i} \times {I}_{i} ) / \sum ( {w}_{i} )$$

where wᵢ represents the weight assigned to the individual occupancy indicator from node i, Iᵢ represents the individual occupancy indicator value from node i, and the summation is performed over all nodes n providing occupancy indicators for a given time-frequency voxel. This normalized weighted sum ensures that the combined occupancy value remains within the valid range while giving greater influence to higher-quality indicators.

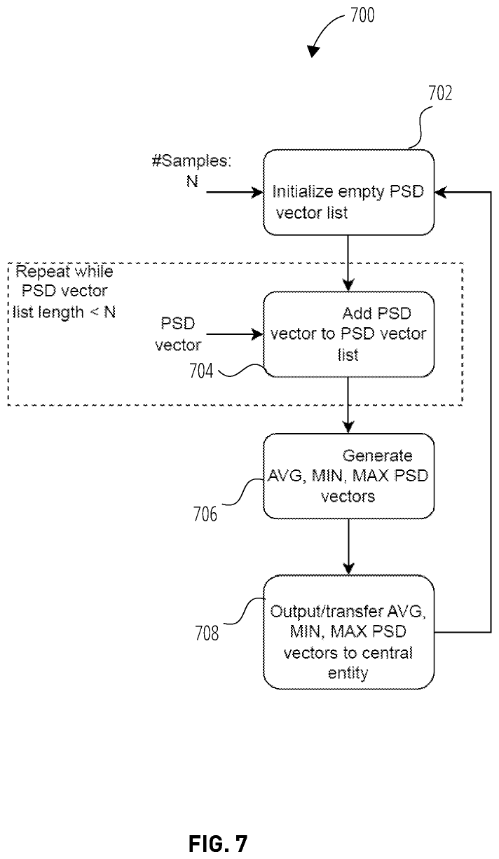

FIG. 7 illustrates a detailed example process for generating and outputting a list of PSD parameter vectors according to the disclosed subject matter.

In this detailed example of process 700, the central node may be operable to initialize an empty PSD vector list (702). For example, the initialized empty PSD vector may also receive a monitoring period threshold, which in this example is a number N samples (e.g., 1000) to be collected by each of the respective nodes. For each sample of the N samples, the respective nodes are operable to generate a PSD vector. The samples may be collected consecutively by each node. Based on the N samples collected by each of the respective nodes, the respective node is operable to add the PSD vector for a respective sample to a PSD vector list (704). For example, received power per frequency bin or power spectral density (PSD) is measured/generated by each respective nodes on a millisecond (ms) basis or even faster, per frontend, for the configured bandwidth of the frontend. Based on the PSD, N consecutive PSD recordings, PSD_1, PSD_2, . . . , PSD_N are collected by a respective node and stored in a data storage. The process of measuring and generating PSD vectors continues until the PSD vector list equals N vectors, where N is the same as the number of samples N. When the Nth entry is made, the respective PSD vectors in the PSD vector list are analyzed and evaluated. The PSD vector list is processed, either by the respective node, a central node, or the like. For each PSD vector list, PSD parameters, such as average PSD, maximum PSD, and minimum PSD, are generated (706). For example, an average PSD of the collected PSD vectors in each frequency is calculated and stored in PSD_AVG, a maximum PSD of the collected PSD vectors in each frequency is calculated and stored in PSD_MAX, and a minimum PSD of the collected PSD vectors in each frequency is calculated and stored in PSD_MIN. It is also envisioned that additional statistics, such as spectral correlation density (SCD), sometimes also called the cyclic spectral density or spectral correlation function, higher-order moments of the extracted phase of the signal or the like, regarding the PSD in each frequency may be generated and/or analyzed.

At 708, the values stored as PSD_AVG, PSD_MAX, and PSD_MIN (and additional statistics) are output for example to a central node (shown in other examples) or other computing entity (not shown). For example, the respective node may output the PSD_AVG, PSD_MAX, PSD_MIN parameter vectors, and additional statistics, if generated, to save bandwidth (or make the data transmission/collection feasible from the start). After transmission of the PSD_AVG, PSD_MAX, and PSD_MIN (and additional statistics) parameter vectors. The list of collected PSD vectors created at step 704, may be emptied so a new monitoring cycle (e.g., PSD collection) may begin.

In this example, N may be automatically adapted based on the network capacity between the respective node(s) and the central unit, such as central unit 110. For example, referring back to FIG. 1, should the communication link capacity between the nodes 102-108 and central unit 110 decrease, the respective nodes or central unit may increase N. Should the communication link capacity increase, decrease N.

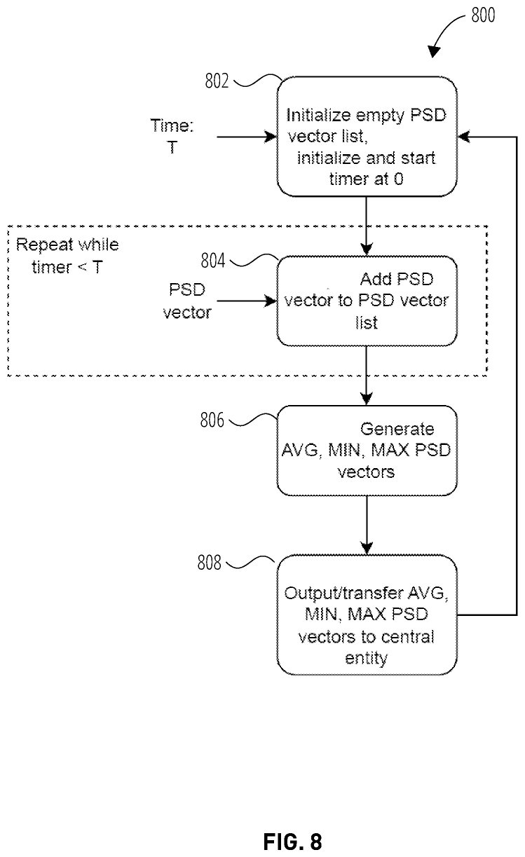

FIG. 8 illustrates another detailed example process for generating and outputting a list of PSD parameter vectors.

In this other example, a given number (e.g., the monitoring period threshold N) of measurements are not aggregated, instead the monitoring period threshold is a time period T (e.g., 1 second, 100 milliseconds, 2 seconds, or the like).

In this detailed example of process 800, each respective node may be operable to initialize an empty PSD vector list (802). For example, the initialized empty PSD vector may also receive a monitoring period threshold, which in this example is a time period T (e.g., 1 second, 100 milliseconds, 2 seconds, or the like) is provided as the monitoring period threshold. The timer in each node is started synchronously in all nodes and the times T may be the same in all nodes. For example, a timer is set to zero and started with an end time set to T, the frequency bin sampling begins. Over the time period T, spectrum (e.g., frequency bin) samples are collected by each of the respective nodes. For each sample in the time period T, the respective nodes are operable to generate a PSD vector. The samples may be collected consecutively by each node. Based on the samples collected by each of the respective nodes during the time period T, the respective node is operable to add the PSD vector for a respective sample to a PSD vector list (804). For example, received power per frequency bin or power spectral density (PSD) is measured/generated by each respective nodes on a millisecond (ms) basis or even faster, per frontend, for the configured bandwidth of the frontend. Based on the PSD, N consecutive PSD recordings, PSD_1, PSD_2, . . . , PSD_X are collected by a respective node and stored in a data storage. The process of measuring and generating PSD vectors continues until the time period T ends. At the end of the time period T, the PSD vector list may have a number of samples, such as X.

When the time period T ends, the respective PSD vectors in the PSD vector list are analyzed and evaluated. The PSD vector list is processed, either by the respective node, a central node, or the like. For each PSD vector list, PSD parameters, such as average PSD, maximum PSD and minimum PSD are generated (806). For example, an average PSD of the collected PSD vectors in each frequency is calculated and stored in PSD_AVG, a maximum PSD of the collected PSD vectors in each frequency is calculated and stored in PSD_MAX, and a minimum PSD of the collected PSD vectors in each frequency is calculated and stored in PSD_MIN. It is also envisioned that additional statistics, such as spectral correlation density (SCD), sometimes also called the cyclic spectral density or spectral correlation function, higher-order moments of the extracted phase of the signal or the like, regarding the PSD in each frequency are generated and/or analyzed.

At 808, the values stored, for example, as PSD_AVG, PSD_MAX, and PSD_MIN (and additional statistics) are output, for example, to a central node (shown in other examples) or other computing entity (not shown). For example, the respective node may output the PSD_AVG, PSD_MAX, and PSD_MIN vectors, and additional statistics, if generated, to save bandwidth (or make the data transmission/collection feasible from the start). After transmission of the PSD_AVG, PSD_MAX, and PSD_MIN (and additional statistics) parameter vectors. The list of collected PSD vectors created at step 804, may be emptied so a new monitoring cycle (e.g., PSD collection) may begin.

Note, that in this example, T may be automatically adapted based on the network capacity between the respective node(s) and the central unit, such as central unit 110. For example, referring back to FIG. 1, should the communication link capacity between the nodes 102-108 and central unit 110 decrease, the respective nodes or central unit may increase T. Should the communication link capacity increase, decrease T.

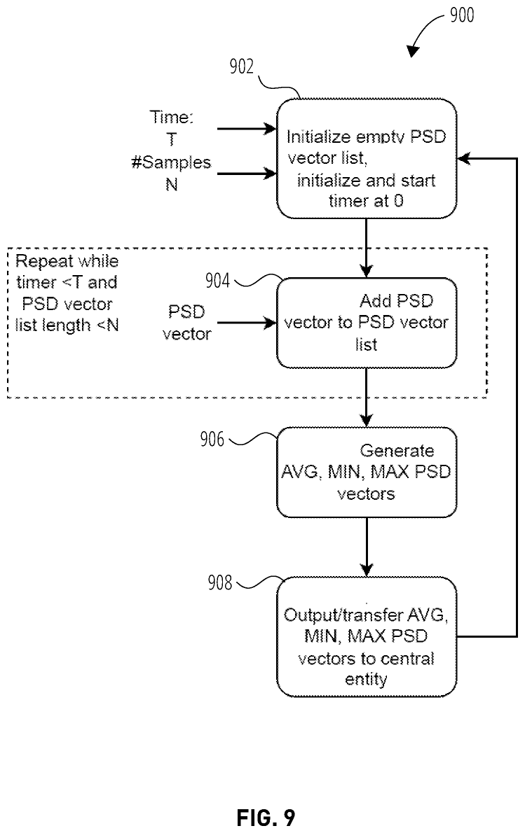

FIG. 9 illustrates yet another example process for generating and outputting a list of PSD parameter vectors.

In this detailed example of process 900, each respective node may be operable to initialize an empty PSD vector list (902). For example, the initialized empty PSD vector may also receive monitoring period thresholds, which in this example is a time period T (e.g., 1 second, 100 milliseconds, 2 seconds, or the like) and a threshold number N of samples. For example, a timer is set to zero and started with an end time set to T, and the frequency bin sampling begins. A counter may be set to count the number of samples M.

While the monitoring period thresholds T and N are being evaluated, spectrum (e.g., frequency bin) samples are collected by each of the respective nodes. For each sample M in the time period T, the respective nodes are operable to generate a PSD vector. The samples M may be collected consecutively by each node. Based on either the samples M collected by each of the respective nodes or the time period T, the respective node is operable to add the PSD vector for a respective sample to a PSD vector list (904). For example, received power per frequency bin or power spectral density (PSD) is measured/generated by each respective nodes on a millisecond (ms) basis or even faster, per frontend, for the configured bandwidth of the frontend. All consecutive PSD recordings for each respective node are collected (stored), PSD_1, PSD_2, . . . , PSD_M, (where M is the counted number of samples) until either the timer exceeds time T and M reaches N, whichever either happens earlier or later. For example, if the monitoring period thresholds are time period T is 2 seconds and the number of samples Nis 1000, and the counted number of samples M exceeds N while the timer has measured only 1.5 seconds, the process 900 continues until the time t exceeds 2 seconds. Similarly, if the monitoring period thresholds remain the same, and the timer has measured 2 seconds, and the counted number of samples M is less than N, the process 900 continues until M equals N. Each M sample is converted to a PSD vector, and when consecutive PSD vectors, PSD_1, PSD_2, . . . , PSD_M are collected by a respective node and stored in a data storage. At the end of the time period T, the PSD vector list may have a number of samples, such as M. Depending upon the spectrum occupancy monitoring system settings, the process of measuring and generating PSD vectors at 904 may continue until the time period T ends and the M number of PSD vectors in the PSD vector list exceeds at least N PSD vectors.

When either the time period T ends or when the number of counted samples M reaches/equals N, the respective PSD vectors in the PSD vector list are analyzed and evaluated. The PSD vector list is processed, either by the respective node, a central node, or the like. For each PSD vector list, PSD parameters, such as average PSD, maximum PSD and minimum PSD are generated (906). For example, an average PSD of the collected PSD vectors in each frequency is calculated and stored in PSD_AVG, a maximum PSD of the collected PSD vectors in each frequency is calculated and stored in PSD_MAX, and a minimum PSD of the collected PSD vectors in each frequency is calculated and stored in PSD_MIN. It is also envisioned that additional statistics regarding the PSD as referenced above with reference to other examples in each frequency may be generated and/or analyzed.

At 908, the values stored, for example, as PSD_AVG, PSD_MAX, PSD_MIN and/or the additional statistics are output for example to a central node (shown in other examples) or other computing entity (not shown). For example, the respective node may output the PSD_AVG, PSD_MAX, and PSD_MIN vectors, and additional statistics, if generated, to save bandwidth (or make the data transmission/collection feasible from the start). After transmission of the PSD_AVG, PSD_MAX, and PSD_MIN (and additional statistics) parameter vectors. The list of collected PSD vectors created at step 904, may be emptied so a new monitoring cycle (e.g., PSD collection) may begin.

Note, that in this example, T or N may be automatically adapted based on the network capacity between the respective node(s) and the central unit, such as central unit 110. For example, referring back to FIG. 1, should the communication link capacity between the nodes 102-108 and central unit 110 decrease, the respective nodes or central unit may increase T, N, or both. Should the communication link capacity increase, decrease T, N, or both.

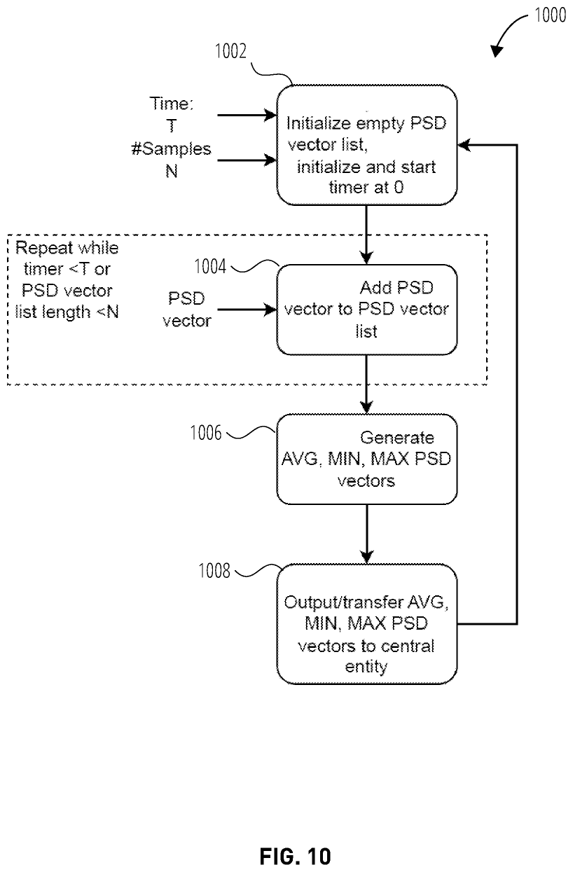

FIG. 10 illustrates yet a further example process for generating and outputting a list of PSD parameter vectors according to the disclosed subject matter.

In this detailed example of process 1000, each respective may be operable to initialize an empty PSD vector list (1002). For example, the initialized empty PSD vector may also receive monitoring period thresholds, which in this example is a time period T (e.g., 1 second, 100 milliseconds, 2 seconds, or the like) and a number N of samples. For example, a timer is set to zero and started with an end time set to T, and the frequency bin sampling begins. A counter may be set to count the number of samples. All consecutive PSD recordings for each respective node are collected (stored), PSD_1, PSD_2, . . . , PSD_M, (where M is the counted number of samples) until either the timer exceeds time T or M reaches N, whichever either happens earlier or later. For example, if the monitoring period thresholds are time period Tis 2 seconds and the number of samples N is 1000, and the counted number of samples M exceeds N while the timer has measured only 1.5 seconds, the process 1000 ends. Similarly, if the monitoring period thresholds remain the same, and the timer has measured 2 seconds, and the counted number of samples M is less than N, the process 1000 ends.

While the monitoring period thresholds T and N are being evaluated, spectrum (e.g., frequency bin) samples are collected by each of the respective nodes. For each sample M in the time period T, the respective nodes are operable to generate a PSD vector. The samples M may be collected consecutively by each node. Based on either the samples M collected by each of the respective nodes or the time period T, the respective node is operable to add the PSD vector for a respective sample to a PSD vector list (1004). For example, received power per frequency bin or power spectral density (PSD) is measured/generated by each respective nodes on a millisecond (ms) basis or even faster, per frontend, for the configured bandwidth of the frontend. Based on the PSD, M consecutive PSD recordings, PSD_1, PSD_2, . . . , PSD_M are collected by a respective node and stored in a data storage. At the end of the time period T, the PSD vector list may have a number of samples, such as M. Depending upon the spectrum occupancy monitoring system settings, the process of measuring and generating PSD vectors at 1004 may continue until the time period T ends and/or the PSD vector list has at least N samples.

When either the time period T ends or when the number of counted samples M reaches/equals N, the respective PSD vectors in the PSD vector list are analyzed and evaluated. The PSD vector list is processed, either by the respective node, a central node, or the like. For each PSD vector list, PSD parameters, such as average PSD, maximum PSD and minimum PSD are generated (1006). For example, an average PSD of the collected PSD vectors in each frequency is calculated and stored in PSD_AVG, a maximum PSD of the collected PSD vectors in each frequency is calculated and stored in PSD_MAX, and a minimum PSD of the collected PSD vectors in each frequency is calculated and stored in PSD_MIN. It is also envisioned that additional statistics regarding the PSD in each frequency will be generated and/or analyzed.

At 1008, the values stored as PSD_AVG, PSD_MAX, and PSD_MIN (and additional statistics) are output for example to a central node (shown in other examples) or other computing entity (not shown). For example, the respective node may output the PSD_AVG, PSD_MAX, and PSD_MIN vectors, and additional statistics, if generated, to save bandwidth (or make the data transmission/collection feasible from the start). After transmission of the PSD_AVG, PSD_MAX, and PSD_MIN (and additional statistics) parameter vectors. The list of collected PSD vectors created at step 1004, may be emptied so a new monitoring cycle (e.g., PSD collection) may begin.

Note, that in this example, T or N may be automatically adapted based on the network capacity between the respective node(s) and the central unit, such as central unit 110. For example, referring back to FIG. 1, should the communication link capacity between the nodes 102-108 and central unit 110 decrease, the respective nodes or central unit may increase T, N, or both. Should the communication link capacity increase, decrease T, N, or both.

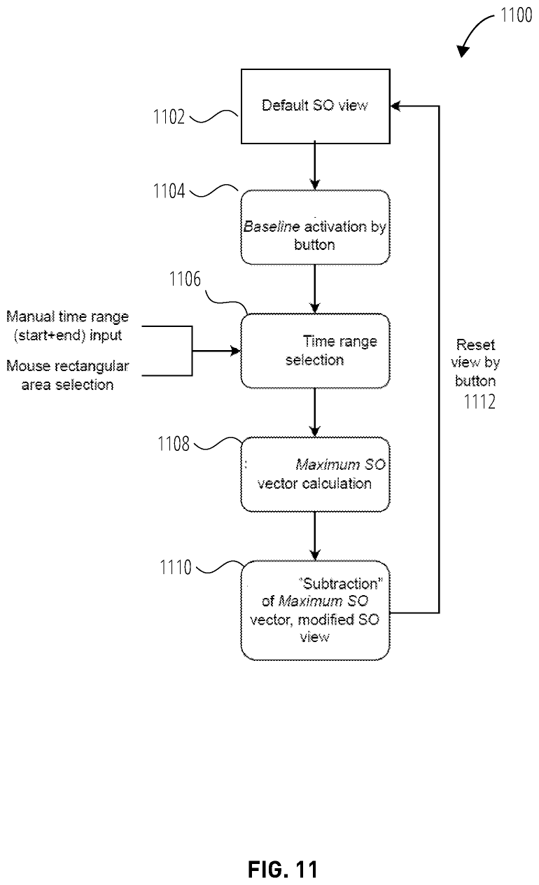

FIG. 11 illustrates an example process for merging spectrum occupancy results into a global spectrum occupancy view according to the disclosed subject matter.

An advantage of the disclosed system is the presentation of the SOM results in an easy to understand format. The presentation may be made using programming code, such as a computer application, or the like, which is executed on a user device, such as output device 114, user device 622, or the like. For example, each user device, whether 114 or 622, may include a processor and memory for storing the programming code.

The process 1100 enables a user to select a time range on the global default SO map (e.g., by selecting an area with the mouse, manual input) that is presented on the user interface (UI).

At default spectrum occupancy view 1102, the UI for displaying the global SO map (shown in a later example) may include a rectangular grid, where, for example, one pixel represents a particular frequency range (horizontal axis) and a particular time range (vertical axis). In the example, the time range (i.e., time resolution, smallest time unit) can be T from above or a multiple of T. The frequency range (i.e., the frequency resolution, the smallest frequency unit) can be the frequency resolution of the frontends, e.g., the bandwidth of each respective frontend may be divided by the length of the PSD vector provided by the respective frontend. The UI allows the user to select a time and frequency range by selecting a sub-area of the shown ranges with the mouse by drawing a rectangle via click-hold-move-release, manual input into the frequency_from, frequency_to, time_from, time_to fields, using the zoom bars with the mouse below/next to the axis, or the like. The UI also allows the user to select the set of nodes/RF channels from which it wants to see the calculated SO, via a dropdown list/checkbox list.

For example, the step of activate baseline view 1104 enables a user to select the “Baseline” feature by activating an input, such as a “Baseline” button presented on a UI. The selected baseline may be a frequency of interest, a period of time, or the like.

Upon selection of the baseline, the process 1100 enables selection of time range at 1106.

At 1106, the time range selection may be received by user input, for example, via a keypad, microphone or the like that indicates a start time and an end time. Alternatively, the UI may be operable to accept an input device selection, such as a mouse, joystick, gesture, or touchpad, of a rectangular area of interest.

After receiving the time range selection at 1106, the processor may be operable to make a spectrum occupancy (SO) maximization vector calculation (1108). For example, the UI calculates the maximum SO vector within the selected time range, i.e., for each frequency being monitored the maximum SO in the selected time range is calculated.

At 1110, the processor uses the calculated SO maximization vector to modify the spectrum occupancy view. The spectrum occupancy view may be modified by subtracting the maximum SO vector from the global SO view. The UI thereafter displays a modified SO for all frequency/time ranges, where all frequency/time units are shown to have zero (0) SO if they have at most as much spectrum occupancy as in the maximum SO. In the example, the subtraction of the maximum SO vector from the global SO view is not permitted to go less than zero.

The UI view may be reset 1112. For example, the “Baseline” can be reset by clicking the “Baseline” button again. In response to the reset, the UI presents the initially displayed global SO map.

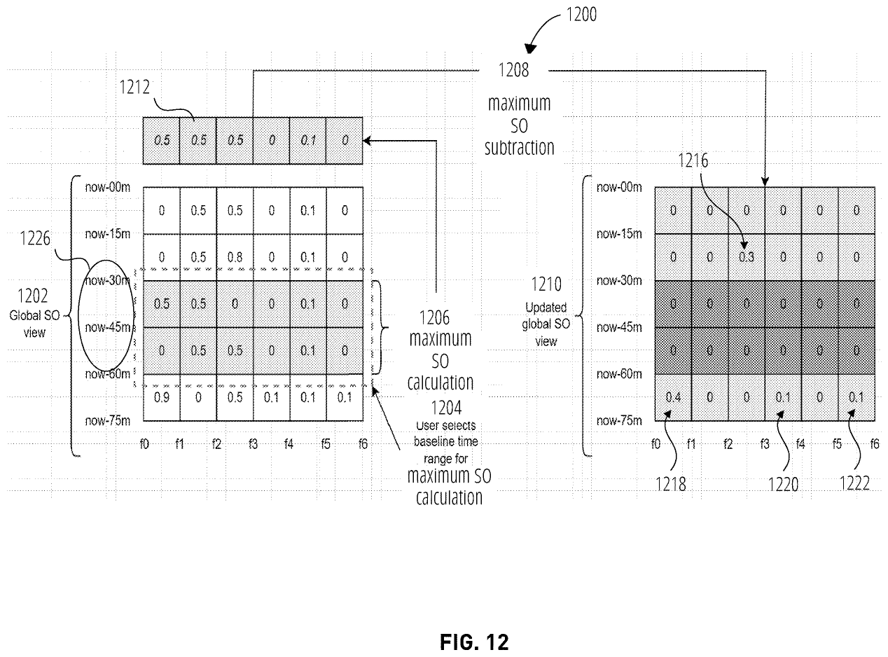

The following discussion of FIG. 12 illustrates another example of modifying the SO view based on a maximum SO vector. FIG. 12 illustrates an example of a process for performing baseline spectrum occupancy subtraction according to the disclosed subject matter.

The process 1200 illustrates in a block diagram an example process for modifying a global SO view 1202. As mentioned with reference to FIG. 11, a user may select baseline time range 1204. The selected baseline time range 1226 is shown as Now −30 m (minutes) and Now −45 m. Each of the PSD vectors for the respective time frames are extracted for maximum SO calculation at 1206. The maximum SO vector resulting from maximum SO calculation 1206 is maximum SO vector 1212. The maximum SO vector 1212 is a set of the highest PSD values in each of the PSD vectors for the baseline time range selected at 1204. As shown in FIG. 12, the first value is 0.5, the second value is 0.5, the third value is 0.5, the fourth value is 0, the fifth value is 0.1, and the sixth value is 0. Each of these values represent a maximum PSD in a different frequency bin within the selected baseline time range.

The processor uses the maximum SO vector 1212 at maximum SO subtraction 1208 to generate updated global SO view 1210. The maximum SO subtraction 1208 operation subtracts the maximum SO vector 1212 from all of the values in the global SO view 1202. As a result of operation 1208, an updated global SO view 1210 is generated. As shown in FIG. 12, only modified SO value 1216, modified SO value 1218, modified SO value 1220 and modified SO value 1222 remain. As a result, the updated global SO view 1210 presents users with only the most extensively occupied portions of the monitored spectrum.

In the example of FIG. 12, the UI allows the user to select a time range with the same methods as in feature A. The UI calculates the maximum SO vector within the selected time range, i.e., for each frequency the maximum SO in the selected time range. The UI thereafter displays a modified SO for all frequency/time ranges, where all frequency/time units are shown to have 0 SO if they have at most as much SO as in the maximum SO. The “Baseline” can be reset by clicking the “Baseline” button again.

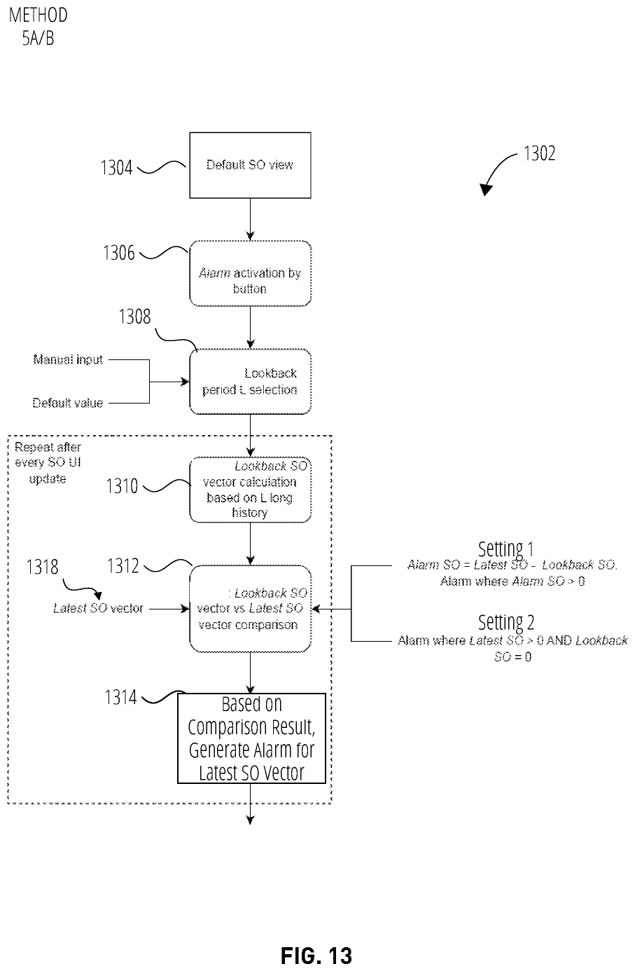

FIG. 13 illustrates an example process for observing spectrum occupancy of a monitored spectrum according to the disclosed subject matter.

The results of the spectrum occupancy monitoring system may be provided for presentation on a user device. A presentation application may be operable to present the results on a user interface. The application may execute process 1302, which begins with a default spectrum occupancy view 1304 being presented on a user interface of a user device. The user may wish to be alerted of certain conditions present in the spectrum occupancy map, and may select an alarm feature. The “Alarm” feature may be activated via an “Alarm” button at 1306.

At 1308, a lookback period L may be selected via a user input device. The lookback period L may be selected via a manual input, while a default value, such as 1 hour, may be selected.

Steps 1310-1314 may be repeated since a lookback SO vector is continuously being calculated based on the lookback period L in a sliding window fashion. The process at 1310 determines spectrum occupancy lookback vector. For example, the lookback SO vector may, at every frequency, be the maximum of SO-s within the lookback period L.

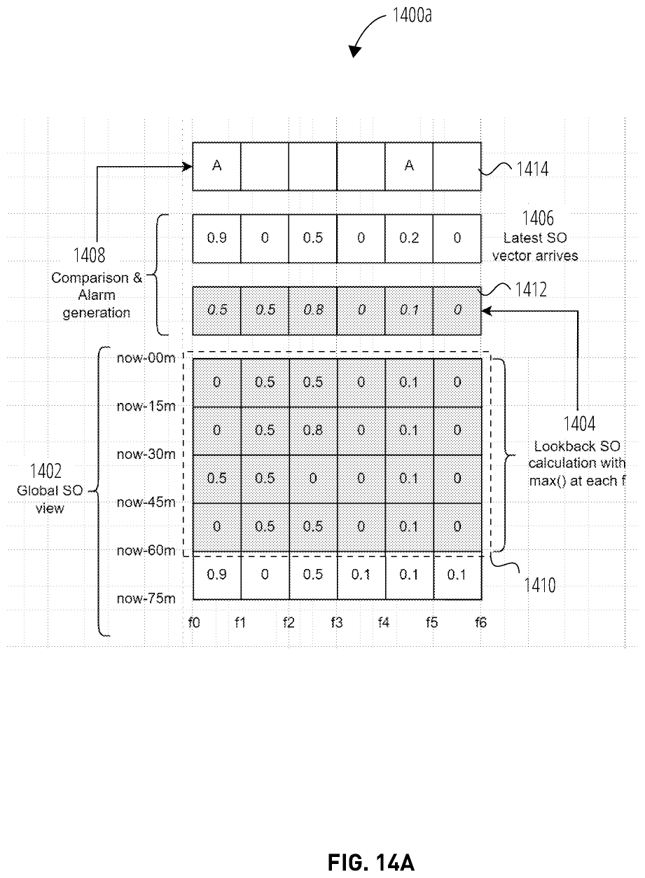

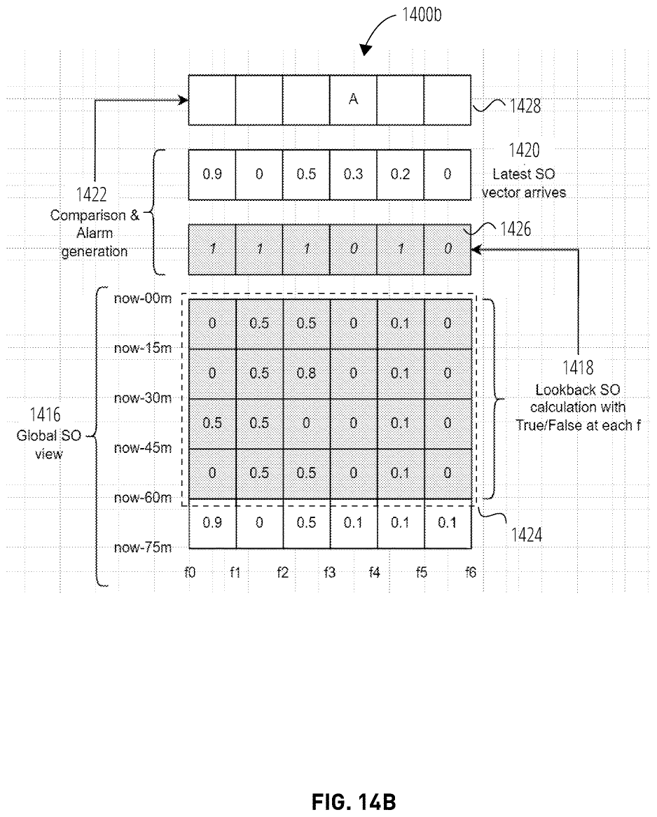

Whenever a new or latest SO vector 1318 arrives, it is automatically compared to the lookback vectors 1312. If the resulting vector contains nonzeros, a visual alert may be generated for the frequencies representing the nonzero SO-s. Depending upon system settings, the application may be operable, in a first example (Setting 1), the resulting vector equals a new SO vector minus the current lookback SO vector (described in more detail with reference to FIG. 14A), while in a second example (Setting 2), the resulting vector equals a new SO vector that is zeroed out at those frequencies where the lookback SO vector is also nonzero (described in more detail with reference to FIG. 14B).

Based on the result of the comparison at 1314, the application may generate an alarm for the latest SO vector.

The following discussion of FIG. 14 illustrates another example for generating an alarm based on a latest SO vector with respect to a lookback period.

FIG. 14A illustrates an example process for generating an alarm based on a latest SO vector with respect to a lookback period according to the disclosed subject matter.

In the process 1400a with an example for Setting 1 (from the example at step 1312 of FIG. 13) with lookback period L being equal to 1 hour is described below.

The process 1400a comprises a global SO view 1402. From the global SO view 1402, a lookback period 1410 is selected by a user via a user input device or by a default setting a lookback SO calculation 1404. The lookback SO calculation 1404 may be made with a maximum PSD at each frequency and provides a lookback SO vector 1412 having the maximum PSD value for each frequency within the lookback period 1410. In the example, a latest SO vector (also referred to a “new OS vector”) arrives every 15 minutes. So, the latest SO vector 1406 may have been received up to 14:59 minutes ago. Of course, new SO vectors may be received within a time less than or greater than 15 minutes depending upon the environment and the conditions being monitored. With an arrival of latest SO vector 1406, the processor may compare the PSD values of each frequency f0-f6 in the lookback SO vector to respective PSD values of each frequency in the latest SO vector at comparison and alarm generation 1408.

Based on a result of the comparison 1414, the comparison and alarm generation 1408 may determine an alarm condition. An alarm condition may be a condition in which PSD values in the arrival of latest SO vector 1406 exceed those in the lookback SO vector 1412. For example, in the frequency bin of f0-f1 of the latest SO vector 1406, the PSD is shown as 0.9 which is greater than the 0.5 value in the same frequency bin in the lookback SO vector 1412. As a result, the frequency bin f0-f1 may be labeled, for example, with an “A.” Similarly, the frequency bin of f4-f5 of the latest SO vector 1406, the PSD is shown as 0.2 which is greater than the 0.1 value in same frequency bin in the lookback SO vector 1412. The label “A” in the comparison result 1414 denotes the frequency in which an alarm will be generated.

The alarm “A” indicates that the frequency where the alarm was generated is now being used, being used at higher power, and/or more frequently, than the particular frequency has been used during the lookback period, or in this case in the last 60 minutes, or 1 hour.

FIG. 14B illustrates another example process for generating an alarm based on a latest SO vector with respect to a lookback period according to the disclosed subject matter.

In the process 1400b with an example for Setting 2 (from the example at step 1312 of FIG. 13) with lookback period L being equal to 1 hour is described below.

The process 1400b, a global SO view 1416, a lookback SO calculation 1418, an arrival of latest SO vector 1420, a compare and alarm 1422, a lookback period 1424, a lookback SO vector 1426, and a comparison result 1428.

The process 1400a comprises a global SO view 1416. From the global SO view 1416, a lookback period 1424 is selected by a user via a user input device or by a default setting a lookback SO calculation 1418. The lookback SO calculation 1418 may be made with a maximum PSD at each frequency and provides a lookback SO vector 1426. However, instead of the lookback SO vector 1426 having the maximum PSD value for each frequency within the lookback period 1410 as would the lookback SO vector 1412 of FIG. 14A, in this example, the lookback SO vector 1426 has a binary indication of whether a PSD value was present or not within the frequency f0-f6 under review. For example, in the selected lookback period 1424, the lookback SO vector 1426 indicates the presence of a PSD value in frequency bins f0-f1, f1-f2, f2-f3 and f4-f5 using a “1” and a “0” indicates the absence of a PSD in frequencies bins f3-f4 and f5-f6.

In the example, a latest SO vector (also referred to a “new OS vector”) arrives every 15 minutes. So, the latest SO vector may have been received up to 14:59 minutes ago. Of course, new SO vectors may be received within a time less than or greater than 15 minutes depending upon the environment and the conditions being monitored. With an arrival of latest SO vector 1420, the processor may compare the presence of PSD values in each frequency in the lookback SO vector to respective PSD values of each frequency in the latest SO vector at the comparison and alarm generation 1408 step.

Based on a result of the comparison 1422, the processor may determine an alarm condition. The alarm condition, in this example, may be the presence of a PSD value in a frequency bin where a PSD value was not present during the selected lookback period 1424. For example, the latest SO vector 1420 has a value of 0.3 in frequency bin f3-f4, while the lookback SO vector 1426 has a “0” for frequency bin f3-f4. As a result, an “A” is generated, and in this example, the label “A” in the comparison result 1428 denotes those frequencies that caused an alarm to be generated.

An advantage of the alarm features of the examples of FIG. 14A and FIG. 14B is that it allows the user to select a lookback period (e.g., 1 hour, 1 day). Thereafter, the background SO may be calculated automatically between a current time and a lookback time period [current time-lookback period], e.g., with 1 hour lookback period, the background SO may continuously be calculated between “now” and “now-1 h” and stored as lookback SO. Upon the arrival of a new, most up-to-date SO vector, such as latest SO vector 1406 and 1420, respectively, is that the latest SO vector 1406/1420 is compared to the lookback SO, and a visual/acoustic alarm may be generated if the new, most up-to-date SO vector indicates additional SO compared to the lookback SO.

The alarm “A” indicates that the frequency, where the alarm was generated, is now being used as compared to the particular frequency not being used during the lookback period, or in this case in the last 60 minutes, or 1 hour.

While two examples of evaluating lookback vectors with respect to a latest SO vector are shown other methods of implementations may be provided, such as using a range of values from the lookback period, or the like.

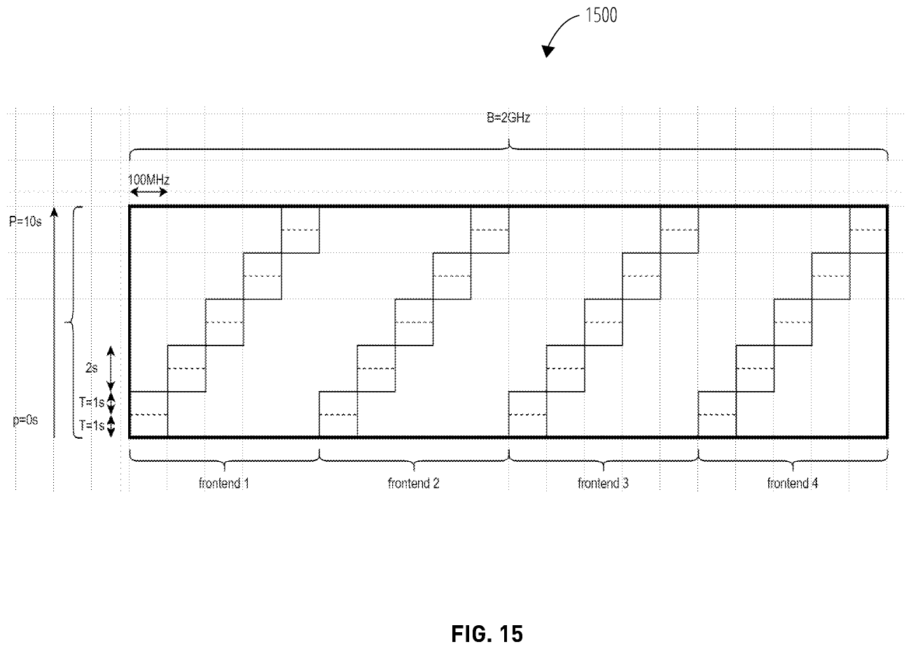

FIG. 15 illustrates an example of partitioning a bandwidth for monitoring according to the disclosed subject matter.

In graphic 1500, a representation of a bandwidth B that is being monitored is shown. The

When the RF channels' total bandwidth is lower than the total to-be observed bandwidth, sweep schedules are used so that frontends are configured to switch frequencies (and potentially bandwidths) and observe different frequency ranges in different time periods. By selecting these configurations in the suitable way, the whole spectrum can be observed, but with parts of it observed not 100% of the time.

At a high level, the process for monitoring the bandwidth B may include: putting at least one but less than J frontends in C and assign fixed subspectrum to them, partitioning the remaining spectrum equally among the frontends in D, instruct each frontend hop/sweep through its assigned subspectrum such that in every subrange of that subspectrum it measures is an equal period of time (in total P).

For example, as shown in FIG. 15, the spectrum occupancy monitoring system utilizes 4 frontends and a time period P=10 seconds. Each of the 4 frontends is monitoring a frontend bandwidth of 100 MHz, and the monitored bandwidth B is equal to 2 GHz. In this monitoring process each frontend is assigned a disjoint range of 0.5 GHZ, and each frontend observes a 100 MHz range for 2 seconds, then hops 100 MHz, and repeats. During the monitoring, a PSD vector is generated and processed as described with reference to the earlier examples. As discussed with previous examples, PSD vectors are generated until a number N of samples are collected and/or a collection time period T has passed. In some examples, the PSD vectors are across the same frequency range and identical resolution. As described in more detail with reference to earlier examples, when either or both of those conditions are met, the recorded PSD vectors are processed to provide the average PSD, maximum PSD, minimum PSD, and/or additional statistics. The average PSD, maximum PSD, minimum PSD, and additional statistics are uploaded to a central unit. Moreover, the processor may be operable to assign for every time-frequency unit (i.e., a time-frequency voxel) a confidence value based on a ratio of truly observed time and the time unit. In the above example P=10 seconds, while the “truly observed time” for any frequency bin may be 2 seconds. Both values are part of the configuration and therefore known by the operator. The confidence of 0.2 is an indicator of how confident the system (e.g., the spectrum occupancy application) is in the resulting occupancy. Using an analogy to vehicular traffic on a highway, assume a system was configured to estimate the traffic on the highway but could only observe only 2 hours per every 10 hour time window. It might happen that in the other 8 hours the traffic is completely different to the truly observed 2 hours (while 10 hours is the time unit), and the system has no way of knowing about the traffic conditions during the other 8 hours.

A time-frequency voxel may, in an example, be defined as a point in a frequency bin that has a frequency (F) that is either occupied (indicated by “1”) or unoccupied (indicated by a “0”) at a particular time T (e.g., 18:01:003). In this example, the time-frequency voxel contains a F, T, and either 0 or 1. In a further example, the time-frequency voxel may also include the confidence value (e.g., 0.2, 0.4, 0.45, 0.55, 0.6, 0.8, 1.0, or the like). Alternatively, or additionally, the time-frequency voxel may be defined in the context of the spectrum occupancy monitoring system. It represents a (smallest) unit of time and a (smallest) unit of frequency, which are associated with the time resolution and frequency resolution of the system. The occupancy value may be a real number between 0 and 1 (inclusive), since the occupancy may be the result of an averaging of occupancy indicators related to that voxel from multiple nodes/frontends.

In Example 1, the confidence value of the observations within the 0-1 GHz range may have an assigned confidence value of, for example, 1.0 or the like, whereas an assigned confidence value of the observations within the 1-5 GHz range may be assigned a confidence value, for example, of 0.5 or the like, where 1.0 is the highest confidence value and 0.0 is the lowest confidence value.

In Example 2, the confidence value of all observations will be assigned a preset confidence value, such as 0.2, 0.3, 0.35, 0.4 or the like, where 1.0 is the highest confidence value and 0.0 is the lowest confidence value.

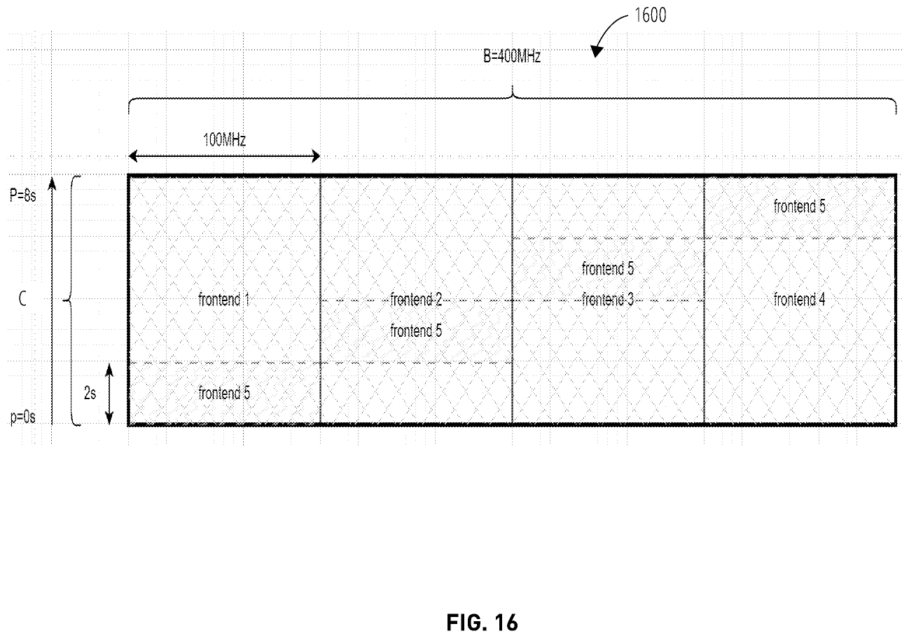

FIG. 16 illustrates another example of partitioning a bandwidth for monitoring according to the disclosed subject matter.

The example method described above with reference to FIG. 15 may be applied even if the sum of bandwidths exceeds B. In an example, a number of frontends, such as Frontends 1-5, may be configured to cover the whole bandwidth (400 MHz) of the spectrum being monitored. In the example, frontends 1-4 are divided according a subband (e.g, 100 MHz) of the spectrum (i.e., the 400 MHz bandwidth) being monitored, while the remaining frontends (e.g., frontend 5) will hop through the spectrum for shorter time periods within the 8 second observation period and add additional information due to multiplexing, or because they are at different locations, etc.

In more detail, the set of frontends F (e.g., 1-5) is partitioned into a subset C which contains those frontends which measure part of the spectrum at a constant center frequency and bandwidth, and the complement subset D=F \ C (i.e., the set of all other frontends) which contains those frontends that are configured to hop center frequencies and potentially change bandwidths in a predefined hopping pattern. In this example, the subset C of frontends includes frontends 1-4, while complement subset D includes frontend 5. The observation period P denotes the time in which the operator aims to have observed the full spectrum bandwidth B. In this example the time period P is 8 seconds(s). The center frequency hops and the bandwidth changes are configured such that after time T, the whole bandwidth B has been observed for at least a minimum time Tₘᵢₙ, Tₘᵢₙ may be the time period P. In this example, Tₘᵢₙ may be 8 seconds, which is the observation period P.

With respect to the preceding example, there can be multiple ways to select C and D, and to configure the hopping frontends. Another example not shown in a figure may be configured where there are F=3 frontends, B=5 GHZ, and P=10 s. Frontend 1 may be configured to continuously observe 0-1 GHz, and frontend 2 may be configured to observe 1-2 GHz for 5 seconds and 2-3 GHz for the next 5 seconds, alternatingly. Similarly, frontend 3 may be configured to observe 3-4 GHz for 5 seconds and 4-5 GHz for the next 5 seconds, alternatingly.

During the monitoring, a PSD vector is generated and processed as described with reference to the earlier examples. As discussed with previous examples, PSD vectors are generated until a number N of samples are collected and/or a collection time period T has passed. In some examples, the PSD vectors are across the same frequency range and identical resolution. As described in more detail with reference to earlier examples, when either or both of those conditions are met, the recorded PSD vectors are processed. In some examples, the PSD vectors are across the same frequency range and identical resolution. Similarly, the average PSD, maximum PSD, minimum PSD, and additional statistics, if needed, are generated, and uploaded to a central unit. In this example, the processing of the recorded PSD vectors and uploading of the average PSD, maximum PSD, minimum PSD, and additional statistics occurs in 1 second increments and prior to a hop or sweep to a next 100 MHz frequency bin.

The example of FIG. 16 shows an implementation with 5 frontends, but additional frontends, such as 6-8, 6-12, or 6-20 may also be deployed.

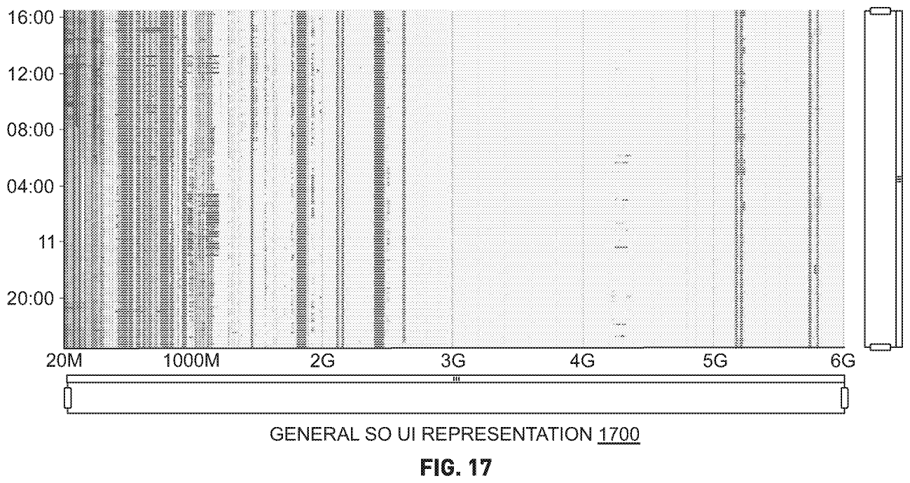

FIG. 17 illustrates an example of a user interface presentation of the output of the spectrum occupancy monitoring system examples disclosed herein.

In the general SO user interface (UI) representation 1700, partial SO results (part=subrange of total observed range) are merged together into one global SO figure where the vertical axis represents time and the horizontal axis represents frequency, and the latter representing the whole observed frequency range. This global SO figure of FIG. 17 is part of a SO UI, which has the following features:
Feature A. The global SO figure can be zoomed in, zoomed out instantly, e.g., by selecting an area with the mouse, selecting a time range with the mouse or by manual input, selecting a frequency range with the mouse or by manual input, or selecting a subset of the nodes from which to display the aggregated SO data.
Feature B. In order to instantaneously show results upon zooming, the SO results are stored at multiple time and frequency resolutions (e.g., if the smallest frequency range is 100 kHz but the global frequency range is 6 GHZ, in this case at least 60 k pixels on the frequency axis to represent the SO; if the smallest time unit is 1 s but the global occupancy map has been stored for 1 day, 86400 pixels would be necessary on the time axis).
Feature C. Baseline feature: this allows the user to select a time range on the global SO map (e.g., by selecting an area with the mouse, manual input). Thereafter, a background SO will be calculated, which, at each frequency, is the maximum occupancy that occurs during the selected background time range. Thereafter, the view of the global SO map may be updated such that it displays only those occupancy values which exceed the background SO. A user selects the range this will be the baseline and any subtraction is not permitted to go less than zero. This allows the user to mask out a “background” SO to which it wants to compare the SO of another time range (e.g., select the nighttime as background and then investigate the SO that is additional to that during the day).
Feature D. Alarm feature: this allows the user to select a lookback period (e.g., 1 hour, 90 minutes, 7 hours, 1 day, or the like). Thereafter, the background SO will be calculated automatically between the current time and [current time-lookback period], e.g., with 1 hour lookback period, the background SO will continuously be calculated between “now” and “now (−) 1 h” (i.e., now minus 1 hour) and stored as a lookback SO. Upon the arrival of a new, most up-to-date SO vector, the up-to-date SO vector is compared to the lookback SO, and a visual/acoustic alarm will be generated if the new SO vector indicates additional SO compared to the lookback SO. For example, an alarm is triggered when the new SO vector is larger than the lookback SO.

The above features are described in more detail with reference to earlier examples.

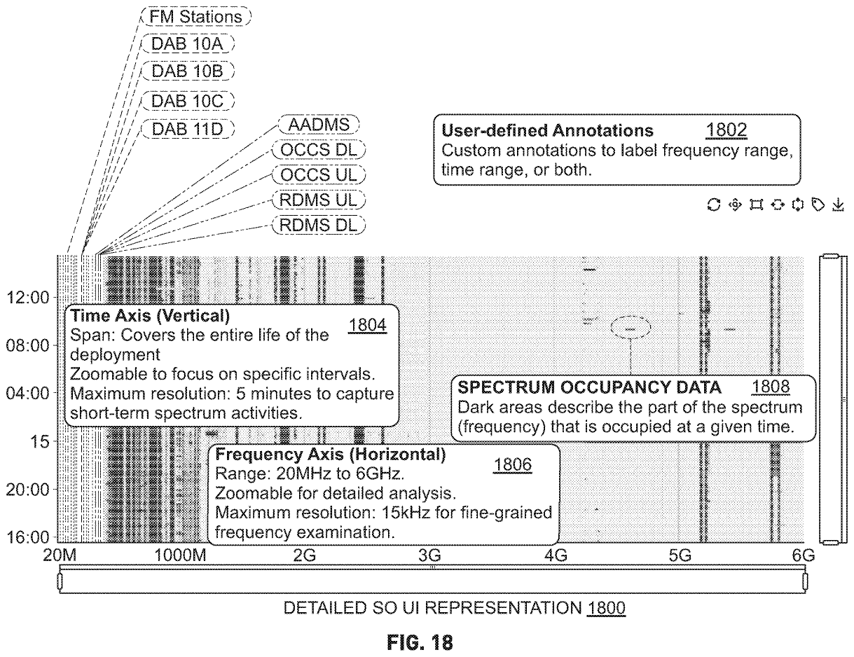

FIG. 18 illustrates another example of a user interface presentation of the output of the spectrum occupancy monitoring system examples disclosed herein.

The UI also enables user defined annotations 1802 that provide user-defined notations that may include custom annotations for labeling frequency ranges (e.g., frequency bins), time ranges, or both. The time axis (vertical) 1804 presents time having a span that covers the entire life of the deployment (e.g., a period of time that the SO is being monitored). The frequency axis (horizontal) 1806 is a selectable frequency range, which in this example shows a frequency range from 20 MHz to 6 GHz, or 0-18 GHz.

The UI also allows the user to select the set of nodes/RF channels from which it wants to see the calculated SO, via a dropdown list/checkbox list.

The global SO figure can be zoomed in, zoomed out instantly, e.g., by selecting an area with the mouse, selecting a time range with the mouse or by manual input, selecting a frequency range with the mouse or by manual input, selecting a subset of the nodes from which to display the aggregated SO data. The maximum zoom may be 15 kHz-100 KHz for fine-grained frequency examination. Of course, depending upon system configurations and device capabilities resolution finer than 15 kHz may be provided. Alternatively, less resolution is also possible to accommodate limitations in communication bandwidth and/or data storage.

The pixel's coloring or opacity represents the SO of the associated frequency/time range (derived by another entity previously from the data received from the nodes). For example, pixel brightness, such as white, indicates greater spectrum occupancy. As such a white pixel indicates greater spectrum occupancy as compared to a black pixel.

On the display device, the pink hue of the data may also indicate that the system (e.g., the spectrum occupancy application) is more confident in being used. These frequencies may be monitored more consistently than other portions. In an example, the confidence value as discussed above is indicative how often the particular frequency was monitored. Alternatively, the color pink or another color, may represent a duration of monitoring.

An additional feature of the application controlling the UI, is that in order to instantaneously show results upon zooming, SO results are being stored at multiple time and frequency resolutions (e.g., if the smallest frequency range is 100 kHz but the global frequency range is 6 GHz, one would need at least 60 k pixels on the frequency axis to represent the SO; if the smallest time unit is 1 s but the global occupancy map has been stored for 1 day, 86400 pixels would be necessary on the time axis).

An additional function is the ability to obtain specific data regarding spectrum occupancy using the spectrum occupancy data 1808. Using this function, a presentation of precise time and frequency may be obtained.

The detailed SO UI Representation 1800 presents the output of all nodes. For example, if only one node sampled a particular frequency and determined the frequency was occupied, the date from the one node is included in the data presented on the UI.

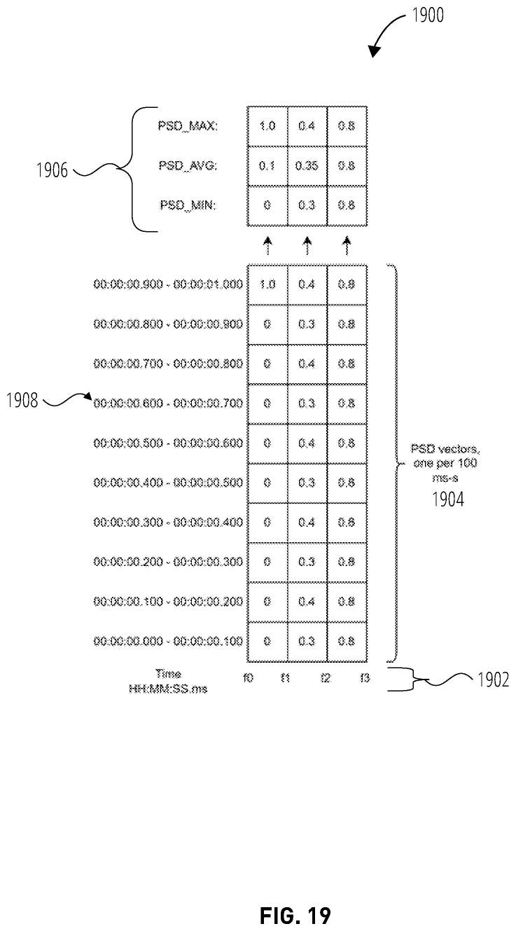

FIG. 19 illustrates an example of a power spectral density vectors and an output of the respective nodes according to the disclosed subject matter. In the example, the vectors 1900 comprise frequency bins 1902, PSD vectors 1904, and a PSD parameters 1906. As shown, there may be power spectral density values for each 100 ms-s that is indicative of the spectrum occupancy of the represented frequency bin (i.e., f0, f1, f2 or f3) 1902 in this example. The PSD parameters 1906 (e.g., Max PSD (=PSD_MAX), Avg PSD (=PSD_AVG) and Min PSD (=MIN_PSD)) may be determined based on the PSD values within each PSD vector for each respective time slot 1908.

The SOM results coming from a wide frequency range, from a large geographic area, over a long time window are impossible for the human operator to ingest and interpret. Simply put, there is too much information for the user to quickly evaluate and respond to effectively especially since given a particular environment, such as a battlefield environment, a rapid evaluation and effective response is necessary to avoid potentially catastrophic consequences. Hence, there is a need for meaningful and informative representation of the information. Examples of intelligence use cases further include informing the user about radio activity that violates predefined constraints related to radio channel utilization and/or temporal restrictions. For example, some radio frequencies are intended not to be used by particular military forces until a certain time frame, or use of a certain radio frequency may indicate the presence of enemy activity, or the like.

To address these concerns, an additional feature included in an example of the disclosed SOM system is a Whiteboard data evaluation and presentation feature that allows the user to define target frequency bands (short: targets) and define constraints that are associated with each of respective target frequency bands. Such constraints relate to the minimum/maximum occupancy/utilization ratio of the target frequency band within a (dynamically defined) time range, e.g., “maximum 30% average utilization in the past 5 minutes, between 2024:01:01 00:00:00 and 2024:12:31 23:59:59.” The constraints are displayed within boxes, one each, which include all related information to help the user in quick judgement of whether a constraint has been violated or not (or is close to being violated).

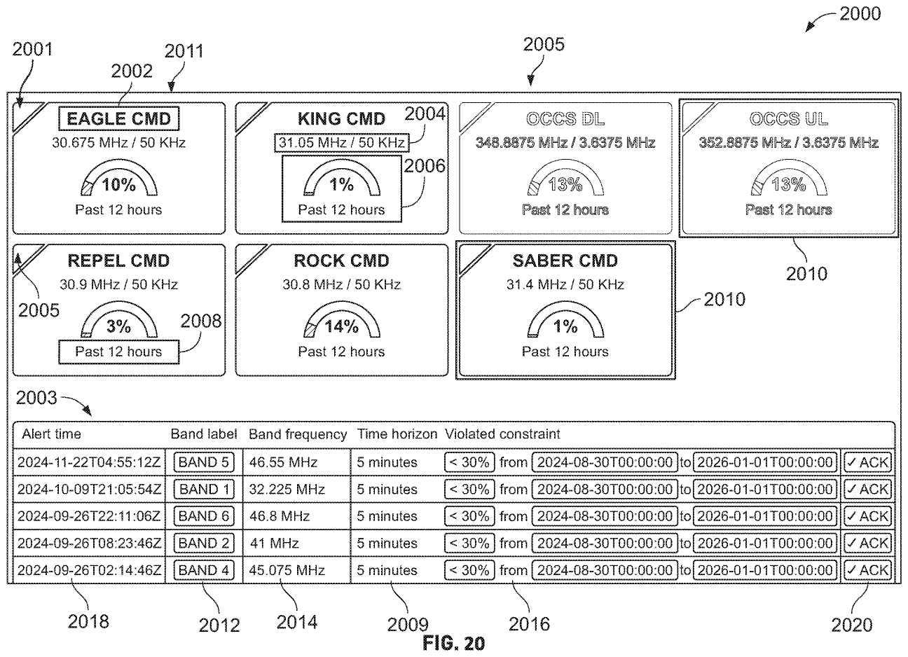

FIG. 20 illustrates an example of a user interface for presenting spectrum occupancy monitoring results according to the disclosed subject matter.

In an example process, a user may define at least one target frequency band by selecting, for example, a triplet parameter setting, such as [target identifier/band label, start frequency-end frequency] or [target identifier, center frequency, bandwidth], or the like, and enters it into the SOM system. Each of the target identifier/band labels, center frequency, bandwidth and start-end frequency may have a unique identifier. In an example, each of the target frequency band identifiers may be uniquely color-coded using, for example, a palette of RGB colors. The user may have the option to select an RGB color for the target frequency band.

User may defines at least one constraint associated with an already defined target frequency band using one or more of: (unique) constraint identifier 2016; (unique) target_identifier/band 2012; time horizon 2009 (e.g., past 5 minutes, past 2 hours, past 30 minutes, or the like); time of activity, within Constraint Description 2016 (e.g., 2024:01:01 00:00:00:2025:01:01 00:00:00 UTC or every day 12:00:00:18:00:00 UTC, or a list of times of activity or a combination of these (e.g., 12:00:00:18:00:00 UTC on weekdays and 00:00:00:23:59:59 on weekend days, till 2025.12.31 12:00 UTC, or the like)); and/or one or more occupancy metric constraints or combinations thereof (e.g., average occupancy not more than 30%, average occupancy, average occupancy at least 50% and at most 90%, or the like). In an operational example, the SO application is operable to receive an identification of a constraint associated target frequency via an input device, wherein the identified constraint includes at least one of a constraint identifier, a target identifier/band label, a time horizon, a time of activity, or one or more occupancy metric constraints. The SO application is further operable to use a violation of the identified constraint, when generating the spectrum occupancy map of the geographical area of interest for presentation on the display device, to update the target panel and/or the constraint violation parameter list.

In the example of FIG. 20, the Whiteboard User Interface 2000 includes a Target panel 2001 and a Constraint Violation Parameter list 2003.

In the example, the Whiteboard User Interface 2000 displays a window, showing, for example, parameters, such as a Target/Band identifier 2002 (e.g., a target identifier), a Center Freq./Bandwidth indicator 2004 (which is the target frequency band center frequency and bandwidth), Observation Window 2008 (also referred to as the “time horizon”), and Occupancy/Utilization Ratio indicator 2006, which may also be referred to as the average occupancy in that time horizon within the target frequency band. Each of the target boxes 2011 in Target panel 2001 may be selected by the user for presentation. Optionally, or in addition, each of the target boxes 2011 in the Target panel 2001 may be annotated with the previously-selected color for the target frequency band (see, for example, the different color coded tab s 2005). The target panel 2001 may present a number of different target boxes 2011. In the present example, only seven target boxes are shown, but any number of targets may be selected and many more may be shown by shrinking the size of the respective target boxes 2011. Alternatively, only target boxes 2011 of the selected targets that have been most active in the selected time horizon may be presented. The Whiteboard User Interface 2000 improves the presentation of complex data thereby enabling a more effective and efficient use of the SOM system.

The SO monitoring system is operable to continuously calculate the target frequency band average utilization (i.e., Occupancy/Utilization Ratio 2006) in the defined time horizons and updates the information in the displayed boxes of Target box 2001. Additionally, the SO monitoring system may be operable to check whether the constraints, shown in Constraint Description 2016, are violated or not. For example, the SO monitoring system may be operable to have settings for periodic constraint checks selected or even aperiodic constraint checks selected.

The SO monitoring system continuously calculates the target frequency band average utilization (e.g., at Occupancy/Utilization Ratio 2006) in the defined time horizons (e.g., time horizon 2009) and updates the respective information in the respective displayed target boxes 2011. In the example, the time horizon 2009 are shown as all being set at 5 minutes, however, the time horizon 2009 for each Constraint Description 2016 can be different. For example, for the (frequency) Band Label 2012, (frequency) Band 5, the time horizon 2009 may be selected by the user via a user input device (e.g., keyboard, keypad, touchscreen, microphone, or the like) Furthermore, the SO monitoring system is operable to check whether the constraints in the constraint description 2016 are violated or not.

If the SO monitoring system determines a constraint being violated as shown in Constraint Violation Parameter list 2003, the SO monitoring system may be operable to generate and store an alarm/alert with the information, such as a timestamp and a target identifier band label. Of course, additional information, such as a time horizon (e.g., duration) of the violated constraint, a specific band frequency (e.g, which may fall within a specified bandwidth of multiple frequencies) may also be stored. The Constraint Violation Parameter list 2003 may include, for example, the most recent alarms (e.g., as many as the user configures or the display allows) that are presented on the UI 2000 with at least the associated target frequency band 2014, the timestamp 2018 (i.e., the time of the activity), and constraint identifier 2016. Optionally, the parameters of the constraint 2016 may also be presented such as the time horizon 2009, a date and time range, a violation parameter time (e.g., a threshold value for activity within the selected Target/Band frequency 2014). In the illustrated example, the threshold is less than 30%; or the like.

Optionally, each alert may be acknowledged (e.g., via Alert time prompt 2020) by the user by pressing a button or some other UI element. In this case, the fact of the acknowledgement (e.g, check mark with ACK) is also stored (in a data storage as shown in other examples) in relation to the alert.

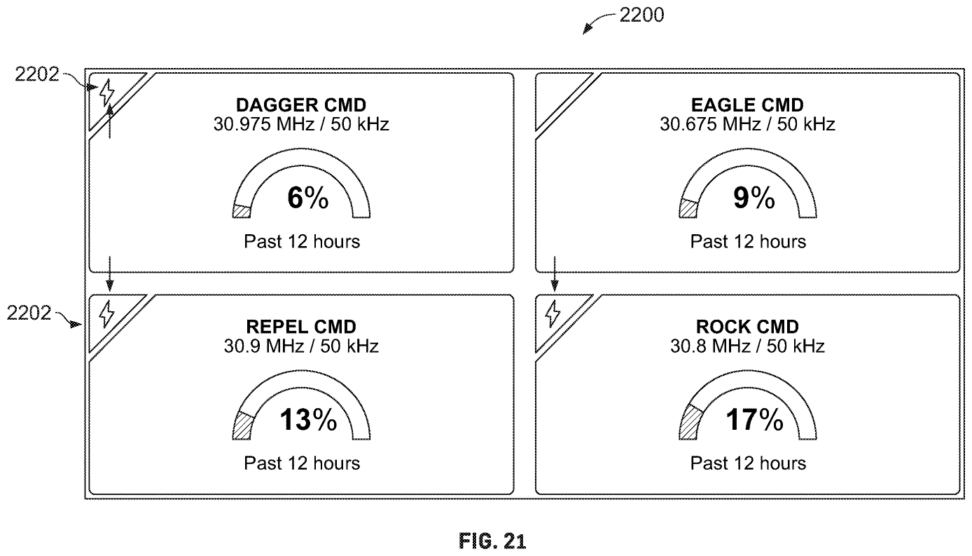

FIG. 21 illustrates another feature of the exemplary first area of the user interface example of FIG. 20. In an example of a response to a constraint being violated, the target frequency band boxes of the whiteboard User Interface 2000 may be flashed and other visual indication (e.g., visual constraint violation indicator 2202 in the color coded tab 2005) can be displayed in case an associated constraint is being violated, e.g arrows to lightening bolts. For example, a change in color of the color coded tab 2005 may indicate a violation, an impending violation, or the like.

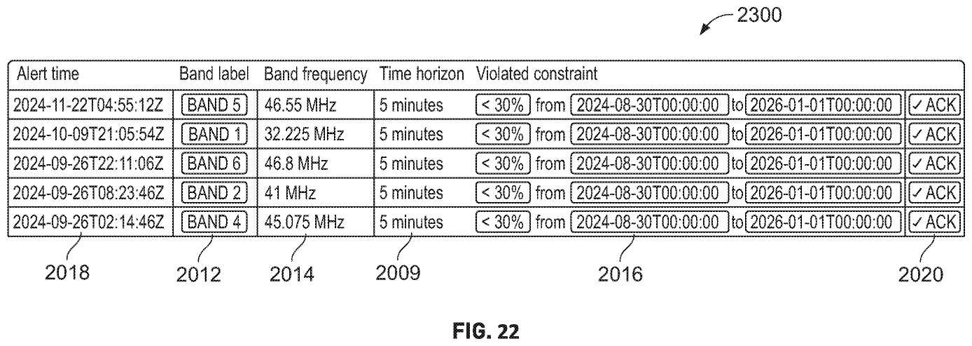

FIG. 22 illustrates an exemplary second area of the user interface example of FIG. 20. The Constraint Violation Parameter list 2300 may include the Alert time indicator 2018, Band Label 2012, Target/Band frequency 2014, time horizon 2009, Constraint Description 2016 and the Alert time prompt 2020. Each of which can present different features related to the Target/Band frequency 2014. For example, the Alert time indicator 2018 indicates the time when the violation identified by the Constraint Description 2016 was actually violated. The Constraint Description 2016 can include a date range and a time range for monitoring (e.g., 2024 Aug. 30 T 00:00:00 to 2026 Jan. 1 T 00:00:00, or the like). Of course, the date range may be the same date and the time range may be a 24 hour period, a 1 hour period, a period of hours, minutes, and seconds, or even represented in only minutes and/or seconds.

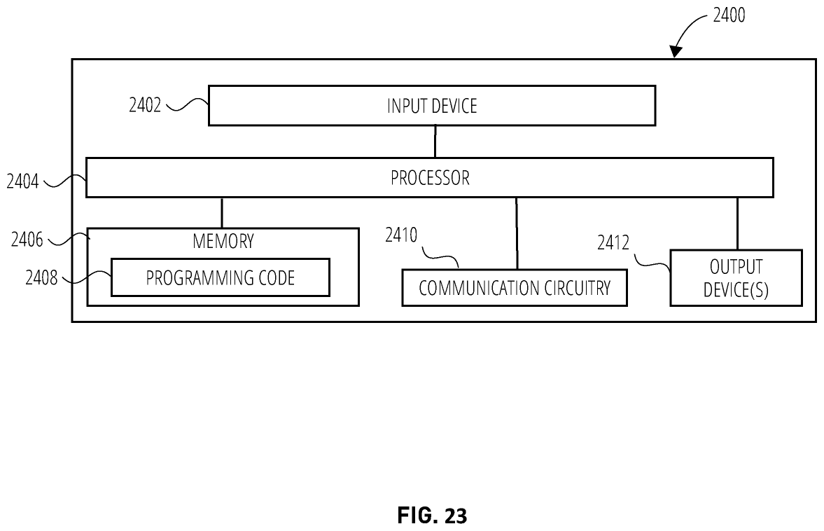

FIG. 23 illustrates an exemplary system for implementing examples of an output device according to the disclosed subject matter.

The exemplary spectrum monitoring system output device 2400 may comprise an input device 2402, a processor 2404, a memory 2406, programming code 2408 stored within the memory 2406, an output device(s) 2410, and communication circuitry 2412, all of which may be communicatively coupled to one another. In an alternative example, the programming code 2408 may be stored elsewhere than the memory 2406, such as a data storage, and be accessible to the processor 2404. In an example, the exemplary spectrum monitoring system output device 2400 may be a tablet, a smartphone, a smart dedicated portable device, a part of a radio transceiver, a workstation, a computer system, an end user device that is part of a secure, cloud-based network, or the like.

The memory 2406 may be a data storage device with various types and configurations of memory devices configured to securely store spectrum occupancy data, user preference settings, spectrum occupancy monitoring data, and the like.

The processor 2404 may be operable to execute the programming code 2408, such as a spectrum occupancy application as described herein, to generate the exemplary Whiteboard User Interface 2000 of FIG. 20 and modify the various parameters based on date received from respective time enhanced, software defined radios, such as 200, or SDRs 102-108. The programming code 2408 may enable, via the input device 2402, the selection of various thresholds and parameters of Constraint Description 2016, and selection of settings for the Alert time indicators 2018 and Alert time prompts 2020. Also, the programming code 2408 may enable via the input device 2402, naming and selection of the Target/Band identifiers 2002, the Target/Band frequency 2014 to be associated with a respective Target/Band identifier 2002, and the like. The programming code 2408 may be encrypted and the processor 2404 may be operable to decrypt the programming code 2408 as well as encrypted data related to the SOM system.

The processor 2404 executing the programming code 2408 may be further operable to cause the presentation of the generated Whiteboard User Interface 2000 on the output device(s) 2410. The output device(s) 2410 may be one or more of audio, visual, tactile, or haptic output devices, such as speakers, a display device, such as a touch screen display, a monitor, or the like; vibrational devices, buzzers, or the like.

The communication circuitry 2412 is operable to enable the processor 2404 to communicate with one or more external devices and systems, such as a data storage, such as 112 of FIG. 1, a central unit, such as 110 of FIG. 1, or even individual SDRs, as well as other devices and system, such as external networks, such as LANs, WANs, cellular networks, data networks, secure data networks, combinations of networks, and the like.

The output device(s) 2412 may be a display device, such as a monitor, a touchscreen display, a tablet, a personal digital assistant

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Indeed, the terms “processor,” “controller,” and the like, are generally used interchangeably herein, and refer to any of the above devices and systems, as well as any data processor.

While this specification contains many specific implementation details, these should not be construed as limitations on the scope of any disclosed subject matters or of what may be claimed, but rather as descriptions of features specific to particular implementations of particular disclosed subject matters. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations. Furthermore, it should be understood that the described program components and systems may, optionally, be integrated together in a single software product or packaged into multiple software products.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips, FPGAs), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A spectrum sensing system, comprising:
A data acquisition platform including a plurality of radio frequency nodes distributed over a geographical area of interest, wherein each radio frequency node of the plurality of radio frequency nodes is operable to:
receive different signals in different radio frequency ranges, and
determine individual occupancy indicators for each of the different radio frequency ranges by preprocessing each received different signal in the different radio frequency radio ranges; and
a spectrum occupancy application executed by a processor and operable to:
receive the determined individual occupancy indicators from each respective radio frequency node of the plurality of radio frequency nodes determined for each of the different radio frequency ranges; and
generate a spectrum occupancy map of the geographical area of interest.

2. The spectrum sensing system of claim 1, wherein the spectrum occupancy application is further operable to:
provide the spectrum occupancy map to a third-party application.

3. The spectrum sensing system of claim 1, wherein the spectrum occupancy application is further operable to:
obtain, from a memory, a power spectral density measurement for each radio frequency of the different radio frequency ranges within the geographical area of interest.

4. The spectrum sensing system of claim 1, wherein the determined individual occupancy indicators include power spectral density measurements for each radio frequency of the different radio frequency ranges within the geographical area of interest, and
the spectrum occupancy application is further operable to:
merge the determined individual occupancy indicators from each respective radio frequency node into the spectrum occupancy map.

5. The spectrum sensing system of claim 1, wherein the determined individual occupancy indicators further include a resource element that is a time-frequency voxel, and the spectrum occupancy application is further operable to:
indicate the resource element as occupied in the spectrum occupancy map when the determined individual occupancy indicators of at least one of the respective radio frequency nodes indicates the resource element is occupied.

6. The spectrum sensing system of claim 1, wherein the determined individual occupancy indicators further include a resource element that is a time-frequency voxel, and the spectrum occupancy application is further operable to:
indicate the resource element as unoccupied in the spectrum occupancy map when the determined individual occupancy indicators of at least one of the respective radio frequency nodes indicates the resource element is unoccupied.

7. The spectrum sensing system of claim 1, wherein the spectrum occupancy application is further operable to average the determined individual occupancy indicators received from each respective radio frequency node when generating the spectrum occupancy map of the geographical area of interest, wherein averaging the determined individual occupancy indicators includes averaging the occupancy indicators for each time-frequency voxel of a spectrum occupancy map presented on a display, wherein the averaging accounts for instances when multiple indicators are presented for a specific voxel.

8. The spectrum sensing system of claim 1, wherein the spectrum occupancy application is further operable to apply a weighted combination scheme to the individual occupancy indicators.

9. The spectrum sensing system of claim 1, wherein each radio frequency node of the plurality of radio frequency nodes further comprises:
multiple channels operable to monitor different radio frequency ranges.

10. The spectrum sensing system of claim 1, wherein the plurality of radio frequency nodes are time synchronized with one another.

11. The spectrum sensing system of claim 1, wherein each respective radio frequency node of the plurality of radio frequency nodes is operable to:
operate in a stare mode, wherein, when in the stare mode, the respective radio frequency node is configured to monitor a portion of the different radio frequency ranges continuously.

12. The spectrum sensing system of claim 1, wherein each respective radio frequency node of the plurality of radio frequency nodes is operable to monitor portions of the different radio frequency ranges discontinuously.

13. A spectrum occupancy monitoring system, comprising:
a plurality of nodes operable to receive signals within a plurality of radio frequency bins;
a central unit operable to communicate with each node of the plurality of nodes, and receive power spectral density vectors; and
a storage device operable to store the power spectral density vectors received from each node of the plurality of nodes wherein each node of the plurality of nodes is operable to provide measured signal parameters,
wherein each node of the plurality of nodes is operable to:
sample the received signals within a selected radio frequency bin of the plurality of radio frequency bins at set time intervals,
generate power spectral density (PSD) data from the samples of the received signals within the selected radio frequency bin,
store the generated PSD data in a list;
generate PSD parameters from the stored list; and
forward the PSD parameters to the central unit,
wherein the central node is operable to:
provide the PSD parameters for each selected radio frequency bin of the plurality of radio frequency bins to the storage device to be stored.

14. The spectrum occupancy monitoring system of claim 13, wherein the samples of the received signals within the selected radio frequency bin are maintained by each respective node of the plurality of nodes in power spectral density vectors that include power spectral data of the received signals within the selected radio frequency bin that are sampled.

15. The spectrum occupancy monitoring system of claim 13, wherein each node of the plurality of nodes is operable to:
repeatedly sample the selected radio frequency bin until a predetermined number of samples is collected, and/or for a predetermined time period.

16. The spectrum occupancy monitoring system of claim 13, wherein each node of the plurality of nodes is operable to:
receive a time reference from the central unit; and
using the received time reference, initiate a clock that is synchronized with each of the other nodes of the plurality of nodes.

17. The spectrum occupancy monitoring system of claim 13, further comprising:
a user device including a processor and a memory, wherein the memory is operable to store programming code and the processor is operable to execute the programming code, and when the processor executes the programming code, the processor is operable to:
present the PSD parameters for each selected radio frequency bin of the plurality of radio frequency bins with a time reference on an output device,
enable application of user-defined annotations to be applied to one or more respective radio frequency bins presented on the output device.

18. The spectrum occupancy monitoring system of claim 13, wherein the PSD parameters include at least one of:
a min PSD vector, a max PSD vector, an avg PSD vector, or additional statistics of PSD.

19. The spectrum occupancy monitoring system of claim 18, wherein the additional statistics of PSD include at least one of:
spectral correlation density (SCD), sometimes also called the cyclic spectral density or spectral correlation function, or
higher-order moments of the extracted phase of the signal.

20. The spectrum occupancy monitoring system of claim 13, further comprising:
a user device including a processor and a memory, wherein the memory is operable to store programming code and the processor is operable to execute the programming code, and when the processor executes the programming code, the processor is operable to:
receive, from a global spectrum occupancy map presented on a display device, a selection of a time range;
in response to the selection of the time range, generate a background spectrum occupancy for the selected time range, wherein the generated background spectrum occupancy includes, at each frequency, a maximum occupancy that occurs during the selected background time range; and
updating the global spectrum occupancy map presented on the display device, wherein the updated global spectrum occupancy map presents only frequencies having occupancy values that exceed the generated background spectrum occupancy.
